(19) United States
(12) Patent Application Publication
(10) Pub. No.: US 2025/0114709 A1
(43) Pub. Date: Apr. 10, 2025

(54) INFORMATION PROCESSING SYSTEM, INFORMATION PROCESSING METHOD, AND NON-TRANSITORY COMPUTER READABLE STORAGE MEDIUM FOR USER-GENERATED GAME SCENARIOS WITH USER-SPECIFIED DIFFICULTY LEVELS

(71) Applicant: WANNA.COM INC., Wilmington, DE (US)

(72) Inventors: Carson COFFMAN, Peculiar, MO (US); James MORRIS, Bloomington, IL (US)

(21) Appl. No.: 18/790,770

(22) Filed: Jul. 31, 2024

Related U.S. Application Data
(60) Provisional application No. 63/543,154, filed on Oct. 9, 2023.

(51) Int. Cl. A63F 13/63; A63F 13/67; A63F 13/69

(52) U.S. Cl. CPC A63F 13/63; A63F 13/67; A63F 13/69

(57) ABSTRACT

A competition is defined for multiple players. Each player defines a game to be played using a GUI, each of the defined games including building blocks selected by the player that defined the respective game using the GUI. Each of the building blocks has an associated difficulty level. The games are differently definable by the players such that different numbers and types of building blocks are selectable by the players in defining their games. Different building blocks are associated with different competitive events. Different players can select the same or different building blocks in defining their games. A value is calculated for each player based on the difficulty levels associated with the building blocks in their games. A result set is determined by comparing the calculated values, the result set representing an ordered list and identifying at least some of the calculated values and/or the players associated therewith.

### CROSS-REFERENCE TO RELATED APPLICATION

This application claims the benefit of U.S. Application Ser. No. 63/543,154 filed on Oct. 9, 2023, the entire contents of which are hereby incorporated herein by reference.

### TECHNICAL FIELD

Certain example embodiments described herein relate to video games in which players compete against one another. More particularly, certain example embodiments described herein relate to competitive video games in which players can design the games that they play.

### BACKGROUND AND SUMMARY

Video games have been around for decades. A relatively recent trend in video game technology relates to open world games. In typical open world games, players generally have large degrees of control over what objectives to pursue and how to pursue them. The gameplay may take place in connection with a defined story arc (or multiple defined story arcs that typically depend on a few key decisions made by players during gameplay), but typically the story will be “told” in a manner that comports with the manner in which the individual player decides to pursue the objectives. The use of fixed levels, and linear gaming/linear storytelling, typically is disfavored in these types of games.

Open world gaming is advantageous because it offers a great degree of flexibility and enables a great deal of player creativity. Unfortunately, however, open world gaming does not lend itself well to competitive games in which different players compete against one another. Although it is at least theoretically possible to enable players to compare scores or numbers/percentages of missions completed/objectives fulfilled, a more direct competitive scenario can be difficult to implement. Part of the technical challenges underlying the implementation of competitive scenarios relates to the very creativity that makes open world gaming fun; that is, because players are free to play the game in a variety of different ways, direct comparisons can be quite difficult. For example, it is not apparent how to compare two players who have decided to pursue different objectives towards the same end. That could be even more complicated when two players pursue different objectives towards different ends. Consider, for example, that it can be difficult to know who is “ahead” as between two players, one who has accomplished more objectives but is farther away from the end of the story, and another who has accomplished fewer objectives but is closer to the end of the story. And if the players are playing in manners that involve different choices that result in different stories being told, the comparison can become even more complex or obfuscated.

It also is technically challenging to give players the ability to navigate a common game space when they could be playing different parts of the game in different ways. A trusted technology-based intermediary may not be able to easily reconcile these differences and provide a fun and fair playing field. Moreover, although players are able to pursue objectives largely in a manner of their choosing, the objectives tend to be preprogrammed. That is, even with open world gaming where there is a lot of player freedom, at least something needs to be fixed in the service of telling the overall story (or stories) and enabling the story arc(s) to “play out” over the course of one or more gaming sessions.

Certain example embodiments help address the above-described and/or other concerns.

One aspect of certain example embodiments enables competitive game play in an environment where different players can pursue different objectives in different manners in connection with a single competition. In other words, one aspect of certain example embodiments enables different players to play different games in the context of a single competition.

Another aspect of certain example embodiments relates to enabling players to define the very objectives that they wish to pursue in connection with a game that takes place in a broader competitive environment with a plurality of different players.

Another aspect of certain example embodiments relates to enabling players to structure the difficulty of the games that they are playing, independent from other players' difficulty selections.

Still another aspect of certain example embodiments relates to a system that facilitates competition between players, even though they may be playing different games in different ways with different difficulty levels. In certain example embodiments, the system facilitates competition between players, even though the players are playing different games with their own respectively-specified objectives and with their own respectively-specified difficulty levels.

The technology disclosed herein includes a system including one or more user devices/terminals, a more centralized management server-type system, and at least links to external systems that may in some instances help define what objectives and difficulty levels are available for selection. Likewise, the technology disclosed herein contemplates user devices/terminals operable within those systems, and the server-type system operable with those user devices/terminals. Counterpart methods (e.g., of defining games, running competitions, etc.) and non-transitory computer readable storage media also are contemplated.

From a technology perspective, certain example embodiments provide technology platforms that improve game management servers and the like, e.g., by managing players' player-defined games. That is, certain example embodiments provide technology platforms that do not set forth game rules or manage individual players' activities, but rather provide technology-based platforms for players to define their own games and enforce a common set of defined standards across those individually defined games, even though the individually defined games may drastically differ from one another in purpose and design. In certain example embodiments, game play is tracked, but players are free to engage in the game play however they see fit.

In certain example embodiments, an information processing system is provided. A memory is operably coupled to one or more processors configured to at least: define a competition for a plurality of players; enable each player to use a graphical user interface (GUI) to define a game to be played for that player in connection with the defined competition, each of the defined games including a plurality of building blocks selected by the player that defined the respective game using the GUI, the GUI being customized for the competition, each of the building blocks having a difficulty level associated therewith, wherein the games are differently definable by the players such that different numbers and types of building blocks are selectable by the players in defining the respective games, wherein different building blocks are associated with different competitive events, and wherein different players can select the same or different building blocks in defining their respective games; for each player, calculate a value based on the difficulty levels associated with the building blocks in the game defined by the respective player; determine a result set by comparing the calculated values for at least some of the players, the result set representing an ordered list and identifying at least some of the calculated values and/or the players associated therewith; and generate for display a first output screen based on the result set.

According to certain example embodiments, the one or more processors may be further configured to determine whether each player has been unsuccessful with respect to any of the building blocks in the games that the respective players defined.

According to certain example embodiments, the one or more processors may be further configured to generate for display a second output screen showing each player that has been unsuccessful with respect to any of the building blocks in the games that the respective players defined.

According to certain example embodiments, the first and second screens may be different from one another.

According to certain example embodiments, for each player that has been unsuccessful with respect to any of the building blocks in the games that the respective players defined, values may not be calculated, and/or may not be considered in the determining of the result set.

According to certain example embodiments, for each player that has been unsuccessful with respect to any of the building blocks in the games that the respective players defined, values may be calculated but not considered in the determining of the result set.

According to certain example embodiments, the values may be calculated in accordance with a predefined formula. For example, the predefined formula may be defined such that the player having selected the most building blocks will not necessarily have the highest possible values.

According to certain example embodiments, the values may be calculated by multiplying together the difficulty levels associated with each building block. For example, the games that have an unsuccessful building block may be ineligible to be listed first in the result set.

According to certain example embodiments, the values may be calculated by combining the difficulty levels associated with each building block.

According to certain example embodiments, the player listed first in the result set may be the game having the highest value and in which there have been successes for all building blocks therein.

According to certain example embodiments, an interface may be provided to an external system, e.g., with the external system having or providing a list of potential building blocks and/or current difficulty levels for the potential building blocks.

According to certain example embodiments, the first output screen may be generated to identify the players having the highest calculated scores, based on the result set, e.g., such that up to a predetermined number of players are identified in the first output screen.

In certain example embodiments, there is provided an information processing method for use with the information processing system disclosed herein, e.g., with the method comprising enabling a given player to define a given game and participate in the competition (or the group competition) with the given game. Similarly, in certain example embodiments, there is provided an information processing method for use with the information processing system disclosed herein, e.g., with the method comprising defining and running the competition (or the group competition). In certain example embodiments, a non-transitory computer readable storage medium tangibly store instructions that, when executed, perform these and/or other information processing methods. Likewise, a user device and/or computing system including at least one processor configured to execute instructions corresponding to one of these and/or other methods.

In certain example embodiments, an information processing system is provided. A memory is operably coupled to one or more processors configured to at least: define a group competition for a plurality of players, wherein each of the plurality of players is assigned to at least one of two or more groups that participate in the group competition such each group has at least two of the players assigned thereto; enable each player to use a graphical user interface (GUI) to define a game to be played for that player in connection with the defined group competition, each of the defined games including at least one building block selected by the player that defined the respective game using the GUI, the GUI being customized for the group competition, each of the building blocks having a difficulty level associated therewith, wherein the games are differently definable by the players such that different numbers and types of building blocks are selectable by the players in defining the respective games, wherein different building blocks are associated with different competitive events, and wherein different players can select the same or different building blocks in defining their respective games; for each player, calculate a value based on the difficulty level(s) associated with the building block(s) in the game defined by the respective player; for each group: determine an intermediate result set by comparing the calculated values for at least some of the players in the respective group, the intermediate result set for the respective group representing a respective list and identifying at least some of the calculated values and/or the players associated therewith, select up to a predetermined number of entries from the respective list that represents the intermediate result set, and determine a respective group result based on the selected entries; determine a group result set by comparing the respective group results; and generate for display a first output screen based on the group result set.

According to certain example embodiments, the one or more processors may be further configured to determine whether each player has been unsuccessful with respect to any of the building blocks in the games that the respective players defined.

According to certain example embodiments, for each player that has been unsuccessful with respect to any of the building blocks in the games that the respective players defined, values may not be calculated, and/or may not be considered in the determining of the intermediate result set.

According to certain example embodiments, the values may be calculated in accordance with a predefined formula and the predefined formula may be defined such that the player having selected the most building blocks will not necessarily have the highest possible values.

According to certain example embodiments, the values may be calculated by combining the difficulty levels associated with each building block.

According to certain example embodiments, an interface to an external system may be provided, with the external system having or providing a list of potential building blocks and current difficulty levels for the potential building blocks.

According to certain example embodiments, for each group, the entries that are selected from the respective list that represents the intermediate result set may be the entries having the corresponding highest calculated values. For instance, for each player that has been unsuccessful with respect to any of the building blocks in the games that the respective players defined, values may not be calculated, and/or may not be considered in the determining of the intermediate result set, and the values may be calculated in accordance with a predefined formula and the predefined formula is defined such that the player having selected the most building blocks will not necessarily have the highest possible values.

According to certain example embodiments, for each group, the entries that are selected from the respective list that represents the intermediate result set may be the entries having the corresponding highest calculated values, except that no player can contribute more than a predetermined number of player entries.

According to certain example embodiments, each game may be required to have more than one building block.

According to certain example embodiments, each group may be required to have at least a minimum threshold number of players assigned thereto in order to be eligible to compete in the group competition.

According to certain example embodiments, the first output screen may be generated to identify the groups having the highest determined group results, based on the group result set, such that up to a predetermined number of groups are identified in the first output screen.

According to certain example embodiments, when a given player accesses the first output screen, the first output screen may be generated to identify the group(s) to which the given player is assigned and to include the group result(s) associated therewith.

According to certain example embodiments, the one or more processors may be further configured to generate for display a second output screen, the second output screen may be generated responsive to a given user selecting a given group in the group competition, and the second output screen may be generated to identify the players having the highest calculated scores for the given group, based on the intermediate result set, such that up to a predetermined number of players are identified in the second output screen.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a block diagram of an example information processing system that may be used to provide a competitive game amongst a plurality of players, in accordance with certain example embodiments;

FIG. 2 is an example game server-side data structure that may be used to define a competition in accordance with certain example embodiments;

FIG. 3 is a flowchart providing an example of how a player can define a game in accordance with certain example embodiments;

FIG. 4 is an example game server-side data structure that may be used to define a game, in accordance with certain example embodiments;

FIG. 5 is a flowchart providing an example of how a competition can be run, in accordance with certain example embodiments;

FIGS. 6-38 are screenshots of an example mobile gaming application that facilitates a competition in accordance with the example approach disclosed herein;

FIGS. 39-46 are screenshots of an example group competition mode, in accordance with the example approach disclosed herein;

FIG. 47 is an example game server-side data structure that may be used to define a group competition in accordance with certain example embodiments;

FIG. 48 is an example game server-side data structure that may be used to define a group, in accordance with certain example embodiments; and

FIG. 49 is a flowchart providing an example of how a group competition can be run, in accordance with certain example embodiments.

### DETAILED DESCRIPTION

Certain example embodiments described herein relate to competitive video games in which players can design the games that they play in the context of a computer-implemented competition. Using the techniques of certain example embodiments, scores can be calculated in connection with a competition being conducted, even though the games may be designed and played differently by different players.

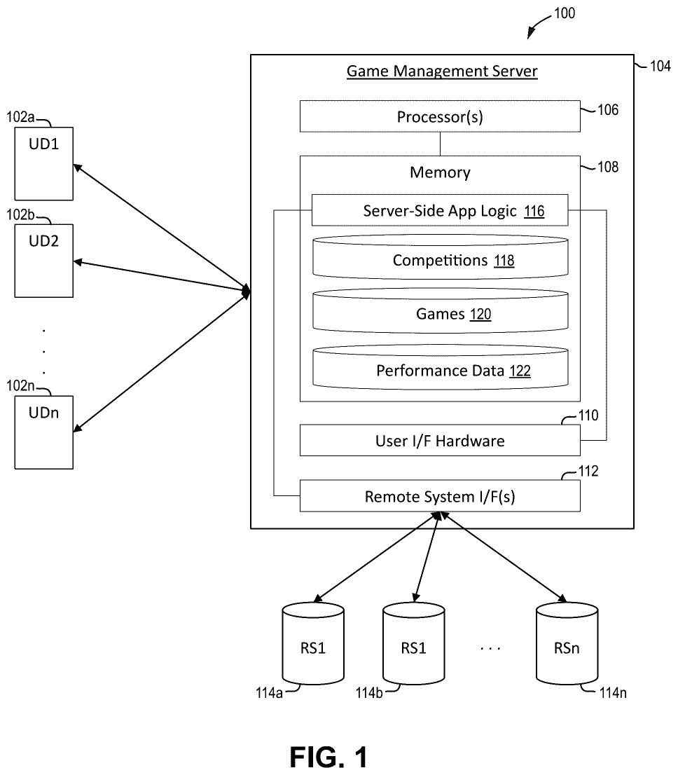

FIG. 1 is a block diagram of an example information processing system 100 that may be used to provide a competitive game amongst a plurality of players, in accordance with certain example embodiments. In FIG. 1, a plurality of players use user devices UD1-UDn 102a-102n. The user devices UD1-UDn 102a-102n may be computers, mobile devices such as smartphones or tablets, dedicated game consoles or portable devices, and/or the like. The user devices UD1-UDn 102a-102n each include at least one processor operably coupled to a memory and user interface elements such as, for example, touchscreen interfaces, keyboards, mice, direction pads, operation buttons, and/or the like. Display devices may be separate from or integral with the user devices UD1-UDn 102a-102n in different example embodiments. As will become apparent from the description that follows, players enroll in competitions, design games, monitor game and/or competition progress, etc., via the respective user devices UD1-UDn 102a-102n. The players access player-side application programs to enter competitions, define games, etc. The player-side application programs are accessible via apps downloaded or otherwise accessible to the user devices UD1-UDn 102a-102n, through remote portals to web applications, etc.

The user devices UD1-UDn 102a-102n are connected to an information management server 104, which may be thought of as a game management server.

Connections between the user devices UD1-UDn 102a-102n and the game management server 104 may include Internet connections, mobile network connections (such as via 4G/LTE, 5G, etc.), Bluetooth, wired connections, and/or the like. The game management server 104 includes at least one processor 106 operably coupled to a memory 108. The memory 108 stores instructions that, when executed, enable the game management server 104 to perform a variety of different operations. For example, the memory 108 of the game management server 104 stores server-side application logic 116 that enables competitions and games to be defined, performance data to be tracked, etc. An authorized user/administrator can interface with the server-side application logic 116 via user interface hardware elements 110. The memory 108 thus stores competition definitions 118, game definitions 120, and performance data 122, which is accessible by the server-side application logic 116.

The game management server 104 includes one or more remote system interface 112 that interface(s) with one or more remote systems RS1-RSn 114a-114n. The remote systems RS1-RSn 114a-114n help define aspects of the games that are designable and playable in connection with the broader competitions. In this sense, the remote systems RS1-RSn 114a-114n may include definitions for playable components, or the remote systems RS1-RSn 114a-114n may include information retrievable by the game management server 104 which can then transform that retrievable information into information relevant to playable components. The remote systems RS1-RSn 114a-114n may be accessible to the game management server 104 through the remote system interface(s) 112 via API calls, web service requests, messaging protocols, and/or the like. In certain example embodiments, the remote systems RS1-RSn 114a-114n, or information from the remote systems RS1-RSn 114a-114n, may be made accessible to the user devices UD1-UDn 102a-102n via the game management server 104, or more directly.

Although FIG. 1 shows just one game management server 104, it will be appreciated that the game management server functionality may be provided via multiple server systems, e.g., in a distributed computing environment such as a cloud computing environment. Moreover, some or all of the data shown as being stored in the memory 108 of the game management server 104 may be spread across multiple different systems in different example embodiments.

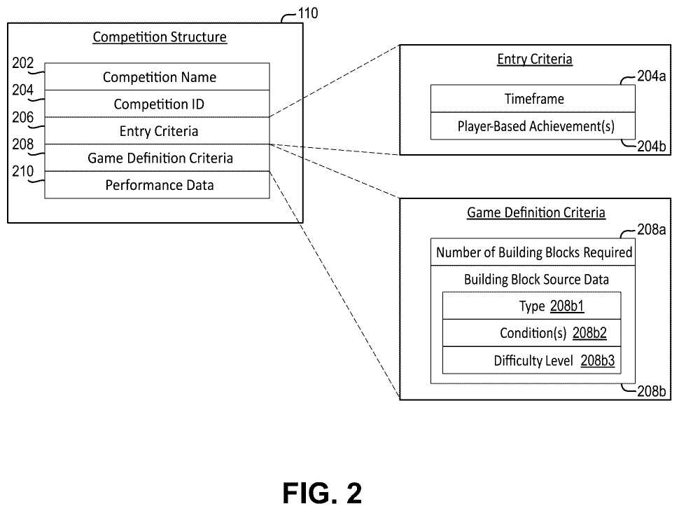

FIG. 2 is an example game server-side data structure 200 that may be used to define a competition in accordance with certain example embodiments. The main competition structure 200 includes a competition name 202 and competition identifier 204, together with entry criteria 206, game definition criteria 208, and performance data 210. As multiple competitions may be run concurrently and/or sequentially by the game management server 104, multiple such structures may be stored in the area shown in FIG. 1 (e.g., the competition definitions 118 of the memory 108 in the game management server 104).

The competition name 202 may be provided by the authorized party. The competition identifier 204 may be unique for the particular competition represented by the data structure 200. Entry criteria 204 may include, for example, a timeframe definition area 204a and player-based achievement(s) definition area 204b that players need to achieve. With regard to the timeframe definition area 204a, a competition may take place over a predefined time period (e.g., a certain number of weeks, days, hours, until a player reaches a predefined score, until all players have lost except for one, and/or the like). Enrollment in the competition by users may be possible for some or all of that time period. For example, enrollment in a given competition may be possible at any point before a defined competition start time, within a certain predefined time window, at any point before the competition ends, etc. Details of the competition's length and/or enrollment times may be stored in the timeframe definition area 204a.

A player may need to satisfy some player-based achievements before entering into the competition. Player-based achievements may include, for example, a player creating an account, a player verifying an account, a player achieving a certain score or reaching a certain level of achievement in prior competitions, etc. With regard to entry criteria based on player-based achievements in prior competitions, some competitions may be reserved for novices or experts, which can make the overall competition more exciting for, and relevant to, those players participating. Thus, for “expert” players, for example, the player-based achievements may specify that enrollment is limited to players who have achieved at least a threshold number of past wins, a threshold total score, a high score in a given competition, a certain level of participation measured in number of competitions entered or number of building blocks (described in greater detail below) deployed or other metric, etc. In a like manner, for “novice” players, for example, the player-based achievements may specify that enrollment is limited to players who have won fewer than a threshold number, have not exceeded a predetermined total score in a single game or as an aggregate across multiple games, have participated in fewer than a threshold number of competitions, etc. Information about player-based achievements is stored in the player-based achievement definition area 204b of the entry criteria 204 in the competition structure 200.

The game definition criteria 208 specifies how players are allowed to construct their games within the competition being defined in the competition structure 200. In general, players define games that take place within a given competition, and individual games are defined by players using building blocks. The game definition criteria 208 provides details of how valid games are to be constructed. For example, a player may be required to select a predefined number of building blocks, or at least a threshold minimum number of building blocks, or a threshold maximum number of building blocks. The requirement is specified in the number of building blocks required area 208a. The building block source data 208b specifies information about building blocks available for inclusion in games conducted under the competition defined by the competition structure 200. For each building block available for inclusion in a game, there is a specification of the type of respective building block 208b1, one or more conditions associated with the respective building block 208b2, and a difficulty level 208b3 associated with the respective building block.

The building block source data 208b may be retrievable in whole or in part from the remote sources RS1-RSn 114a-114n in certain example embodiments. For example, a first remote source may provide stages of one or more video games. Conditions associated with them may include collecting a certain number of coins, progressing to an end location (e.g., within a specified time period), staying alive for a certain amount of time, defeating an enemy character, etc. The difficulty level may be preprogrammed, or it may be based on crowdsourced information, real gameplay data indicative of how hard the level is, etc. Crowdsourced information relating to difficulty may include, for example, an aggregation of rankings on a predetermined scale (e.g., user-based ranking on a scale of 1-10 or the like), categorical labels (e.g., very easy, easy, average, hard, very hard), etc. Real gameplay data indicative of how hard the level may be, for example, average number of attempts needed to clear a level, amount of time needed to clear a level, number of failures prior to clearing a level, etc. The real gameplay data for a given level may be comparative relative to other levels.

In a similar vein, a second remote source may provide one or more mini-games from a video game provider. These building blocks may require players who select them to actually play through something, e.g., via their respective user devices. The condition information is stored in the conditions area 208b2 of the building block source data 208b, and the difficulty level information is stored in the difficulty level area 208b3.

Additional remote sources may provide a system allowing players to select outcomes from certain real-world events. For instance, a third remote source may enable to select sports related outcomes. The sports related outcomes may include, for example, a team beating another team outright, a team beating another team by a certain amount (or not), an individual player's performance, a group of players' performances, etc. The difficulty level associated with the building blocks selectable from the third remote source may be tied to the odds associated with the event occurring (or not occurring), a fantasy points calculation rewarding the player selecting the building block in dependence on real world performance metrics associated with the building block, and/or the like.

A fourth remote source may enable to select outcomes related to other real-world events such as, for example, weather-related events coming to pass, a person winning an election, number of tickets sold for a concert, etc. Some events (like weather-related events) will have odds attached based on simulations, and that information can be used for difficulty level metrics. Others may be set by an authorized user.

Performance data 210 may include how well players are performing for the competition. It may be updated in real-time in certain example embodiments, e.g., if some events take place during the length of time that in which the competition is running.

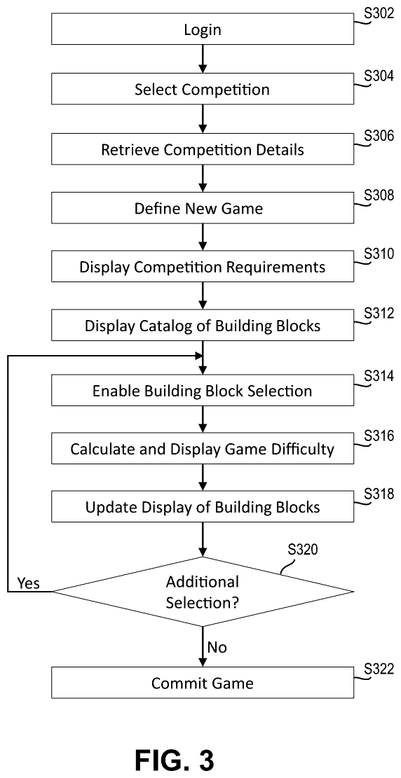

Collectively, the type of information shown in and described in connection with FIG. 2 can be used to define competitions, as well as players' games within a given competition. FIG. 3 is a flowchart providing an example of how a player can define a game in accordance with certain example embodiments. As shown in FIG. 3, in step S302, a player logs in or otherwise starts an application on player's respective user device. The player selects a competition in which to participate in step S304. As noted above, one or more competitions may take place at the same time or in sequence, so a player may be able to enter one or more competitions at a time. In certain example embodiments, a player may only select a competition that the player is eligible to participate in, e.g., based on a ranking, paid entry, or the like. Thus, a filter process may be implemented to determine which competitions the player can participate in (e.g., by checking whether the player meets the entry criteria specified in the various competition structures associated with the competitions that are running), and only those that competitions that the player is eligible to participate in are displayed. Alternatively, all competitions for a given timeframe may be displayed but those for which the player is ineligible may not be selectable (e.g., they may be “grayed out” or the like).

When a valid competition is selected, in step S306 additional competition details are retrieved including, for example, baseline conditions for participating in the competition. This may include building block requirements, for instance. The player can then define a new game in step S308, and competition requirements can be displayed along with a catalog of building blocks selectable in connection with the game that the player is defining (steps S310 and S312). For instance, a player can select stages from video games, head-to-head winners in sporting events, individual players' fantasy performance metrics, and/or the like. Building block selection is enabled in step S314 and, once a building block is selected, the game difficulty is calculated and displayed for the user in step S316. As discussed above, the difficulty level may be preprogrammed, based on published odds, etc.

Once a selection is made, the display of building blocks is updated in step S318. If there are no more selections to be made (as determined in step S320), the game is committed in step S322, and the player can play and/or await the outcome of the game (e.g., if it is to take place based on events occurring in the future). Otherwise, further building block selection is enabled. In certain example embodiments, a minimum threshold number of building blocks will be required, and the determination in step S320 may be based on whether the game being defined includes at least the minimum threshold. In that sense, the player defining the game may be forced to make more selections (and thus prevented from committing the game) if the threshold is not met. In a similar vein, a maximum number of building blocks may be specified. In certain example embodiments, the determination in step S320 may take into account whether the player has met this maximum threshold. In certain example embodiments, the player will be prevented from selecting more building blocks than the maximum threshold. In certain example embodiments, the player may make more selections than the maximum threshold, but will be prevented from committing the game until a suitable number of building blocks have been removed so as to comply with the maximum.

The game difficulty calculation may take place in accordance with a predefined calculation. For example, the difficulty levels may be multiplied together to arrive at a final game difficulty level. As another example, the difficulty levels may be added together to arrive at the final game difficulty level. In still other examples, weighting may be applied for different building block types (e.g., to favor or disfavor certain types of building blocks), for different users (e.g., to level the playing field for novices competing against experts), etc. The calculation used to compute the final game difficulty level may be stored in the competition data structure 200 shown schematically in FIG. 2, e.g., with the performance data 210.

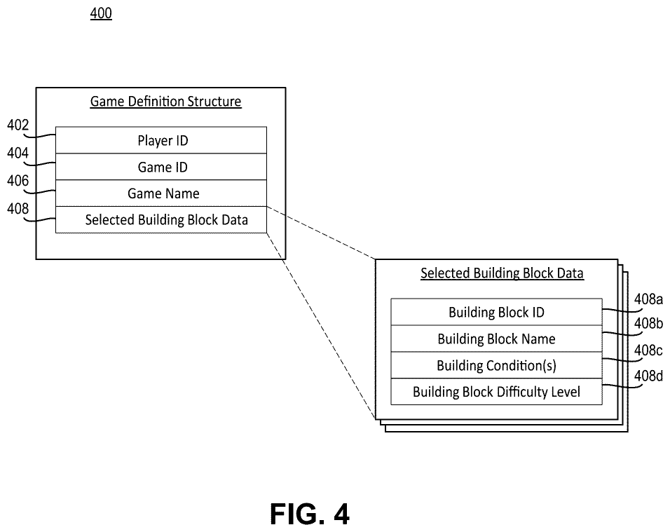

FIG. 4 is an example game server-side data structure 400 that may be used to define a game, in accordance with certain example embodiments. As shown in FIG. 4, the game definition structure includes an identifier 402 of the player who defined it, as well as an identifier 404 for the game itself. A more user-friendly game name 406 may be associated with the game definition structure 400, as well. The competition(s) to which the game definition structure applies also may be identified. Selected building block data 408 is provided and, as will be appreciated from the above, it will include building block identifying information 408a such as, for example a building block identifier, a building block name 408b, one or more conditions 408c associated with the building block, and the building block's difficulty level 408d. It is noted that difficulty levels may or may not vary over time. For example, in the sports world, betting lines may move as a game gets closer, weather forecasts may become clearer as a date approaches, etc. In certain example embodiments, the difficulty level may be “locked in” at the time of player selection. In other cases, the difficulty level may move over time, and the actual difficulty level used may be the “final” difficulty level at or just before a game is played (for example). Whether the difficulty level is locked or movable may be specified as an aspect of the competition.

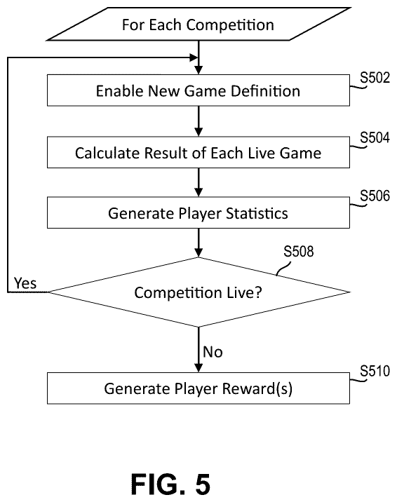

FIG. 5 is a flowchart providing an example of how a competition can be run, in accordance with certain example embodiments. For each competition, new game definition is enabled in step S502, e.g., based on the process shown in and described above in connection with FIG. 3. A result is calculated for each “live” game in step S504. A live game may be a game that is created within the time period by a valid user. In certain example embodiments, once a player loses any part of a game, the game may be treated as no being longer “live.” In other words, that particular game may be treated as a bust in a parlay.

To calculate the results of each live game, the game management server may interface with applicable remote servers to determine the outcomes of the building blocks. If the player has completed a game with a difficulty level, that may be taken into account. If the player selected a team to win (and it did), the odds of the victory may be taken into account. Interim results may be determined based on the predefined calculation methodology, examples of which were provided above.

Once the results of the live games are calculated, player statistics are calculated in step S506. The calculation of the player statistics may include a simple ordering based on the interim results. The player statistics may be displayable in connection with a leaderboard or the like accessible via the player-side application. If the competition is still live, then the process continues. If the competition has ended (e.g., a time has elapsed, a player has accomplished a certain objective, etc.), in-game player reward(s) may be distributed to players in step S510.

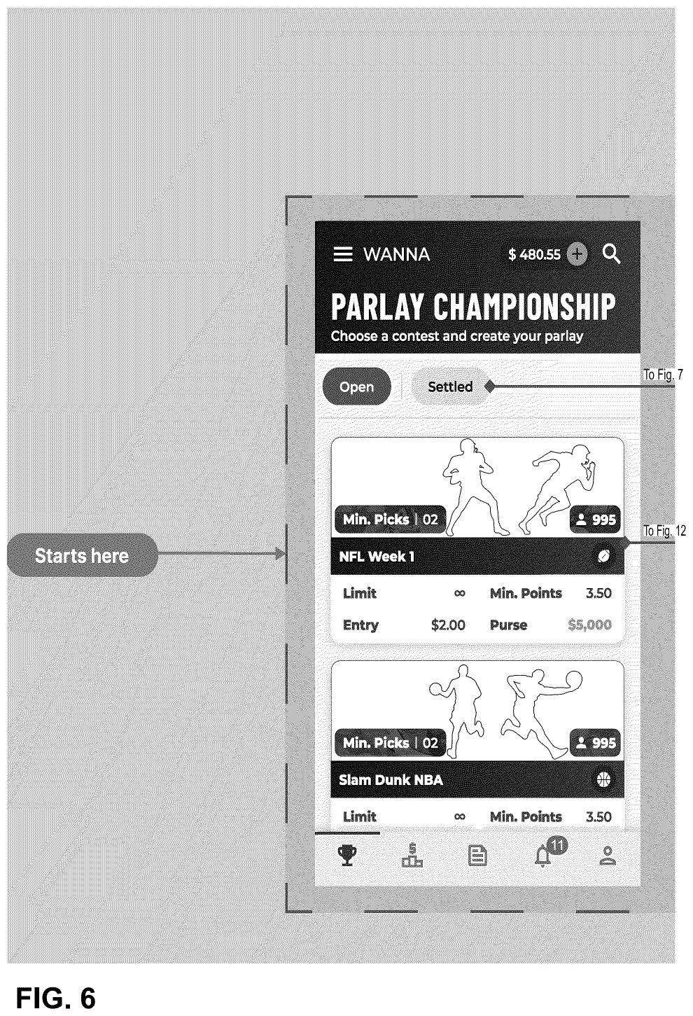

FIGS. 6-38 are screenshots of an example mobile gaming application that facilitates a competition in accordance with the example approach disclosed herein. These example screenshots provide a player perspective of how a competition may take place, including how a game may be defined. Navigation between screens is indicated in connection with the various figure numbers. One skilled in the art will understand the navigation between screens based on this layout, especially in connection with the connecting lines. It will be appreciated that these screenshots present an example flow through an app that may be accessed by a player via a mobile device or the like. Different screenshots or user interfaces may be provided in different example embodiments. Moreover, the various competitions, games, building blocks, options, etc., are provided by way of example and without limitation unless specifically claimed.

FIG. 6 is a screenshot of a home page a player can use to choose a contest to enter, in accordance with certain example embodiments. Competitions (or contests) can vary, e.g., by sports league(s) or other areas from which building blocks can be selected, entry limit, entry cost, prize amounts, number of participants, etc. The competitions also have minimum requirements for the parlayed building blocks that form the games therein. These minimum requirements can include the number of building block selections required (e.g., minimum, maximum, or set number), minimum calculated value assuming wins (e.g., to help guard against one person playing a “safe” game while others develop complicated games), etc. Some or all of this information is displayed on the FIG. 6 screenshot. For example, the FIG. 6 screenshot shows two different competitions, one for the NFL and one for the NBA. A unique name is applied to each. For the NFL Week 1 example competition, the information shown includes the minimum number of building blocks needed for a game (in this example 2), the limit on the number of participating players (in this case, there is no limit), the minimum required points, the entry cost, and the prize. The number of participating players already signed up also is shown (in this case, it is 995). The FIG. 6 screenshot shows open competitions, and the player can select the “settled” button to see those that are completed. Selecting an open competition brings up details for that competition. It thus will be appreciated that the app presents a graphical user interface that is customized for this particular competition.

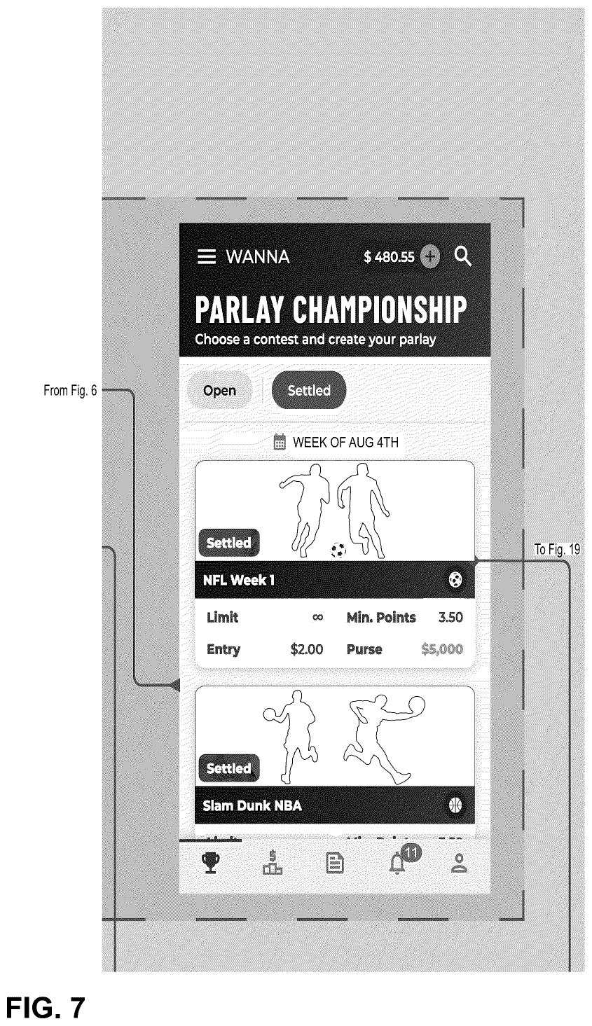

FIG. 7 is a screenshot showing past competitions, in accordance with certain example embodiments. By studying past competitions, players can gain information about how contests were won. For example, players can study the players who won grand prizes in past competitions to deduce winning strategies about how to build winning games in the future. Information that may be gleaned may include, for instance, information about the most common point value that wins prizes (implying that there is no reason to select building blocks to build games that could exceed this value because doing so would only make it harder for that player to win), the number of building blocks in typical wins, how many games a player typically submits for a given competition and how many of them typically win, which types of building blocks (e.g., levels, bet types, etc.) that typically are included in winning games, etc. This and other information may be stored in a database or other structure on or accessible to the game management server 104 shown in FIG. 1.

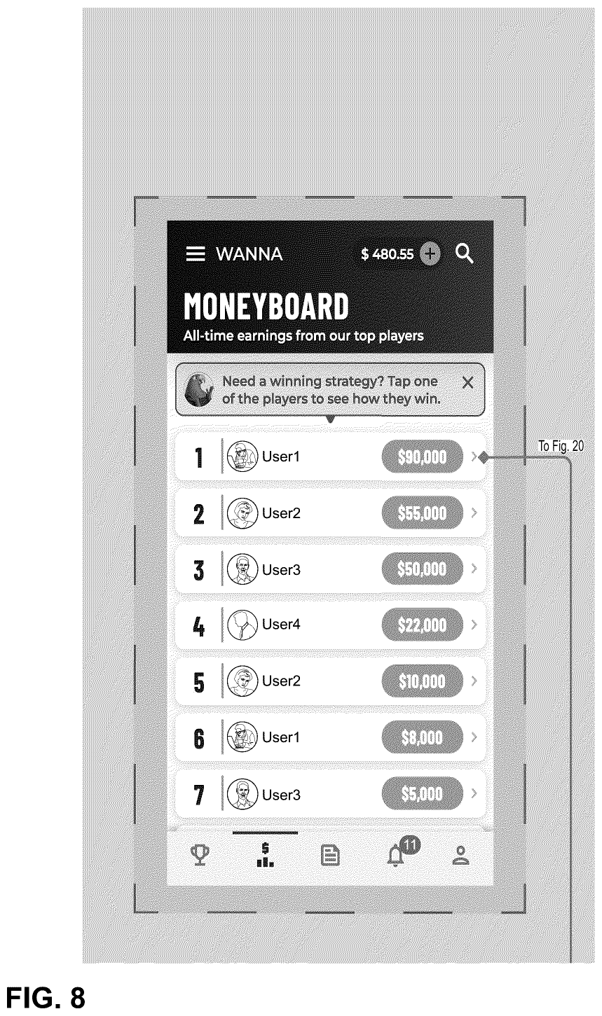

FIG. 8 is a screenshot with a list of the “all-time” winners, i.e., a subset of the winners who have the greatest scores aggregated across competitions over time, in accordance with certain example embodiments. The FIG. 8 screenshot helps “promote” these players. By selecting an entry from the FIG. 8 list, the player making the selection can see the competitions (past and/or present) entered by the player corresponding to the entry, including the games and how they were constructed. Making this information available can help level the playing field, e.g., by giving players access to historical and current information about those who win the most, and by giving players the chance to develop their own winning strategies based on this information.

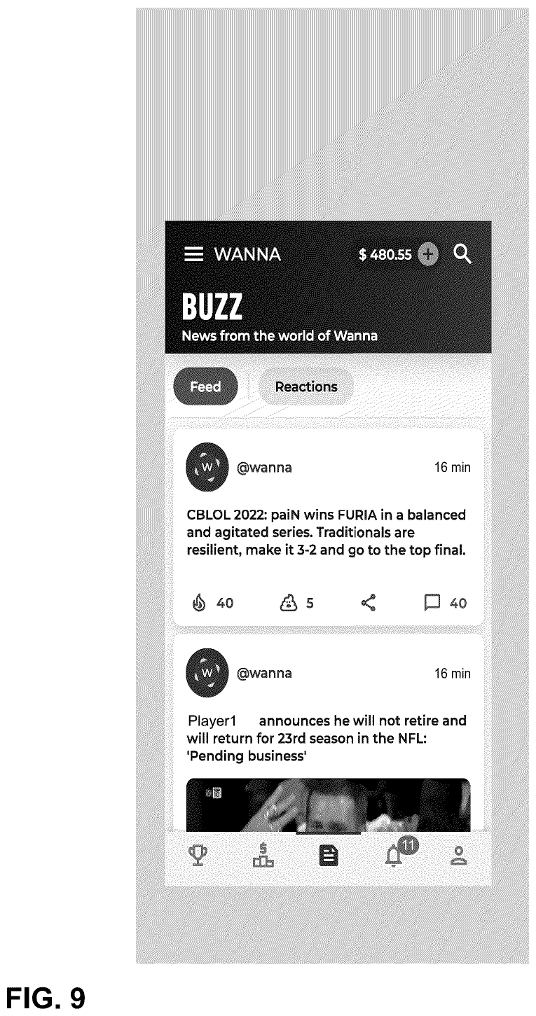

FIG. 9 is a screenshot showing a feed of news items relevant to the platform, in accordance with certain example embodiments. The news feed may include, for example, news items relevant to the competition(s) that is/are running. It is possible for players to like or dislike entries in the feed, share them (internal or external to the app, e.g., via dedicated in-app messaging, SMS messaging, emails, etc.), and provide comments. Reactions to news articles also can be seen.

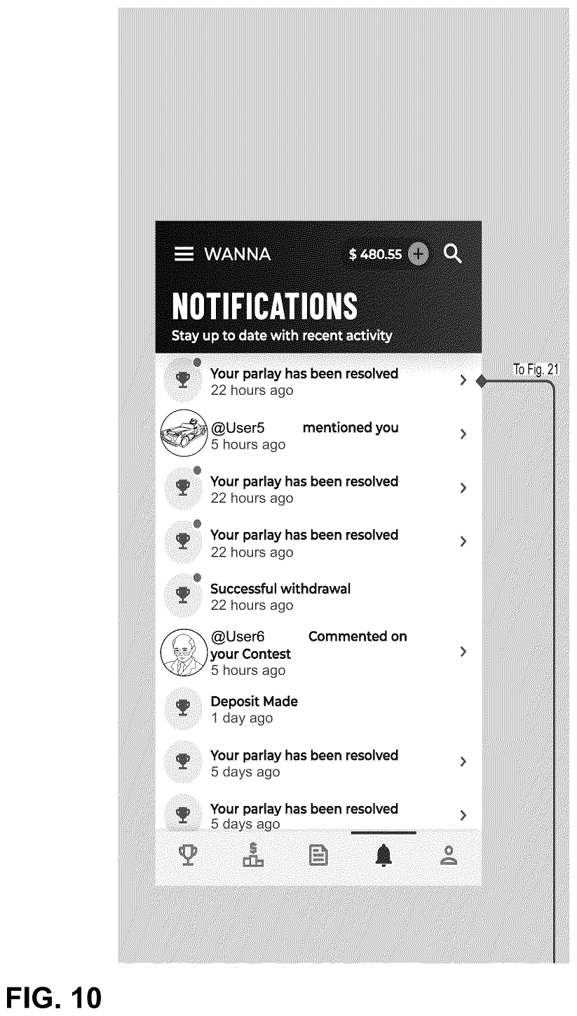

FIG. 10 is a screenshot showing notifications related to the platform, in accordance with certain example embodiments. These notifications may include, for example, whether competitions are open or closed, whether competitions and/or games therein have been resolved, whether someone has mentioned another player in a post, whether someone has commented on a post made by the player using the app, etc.

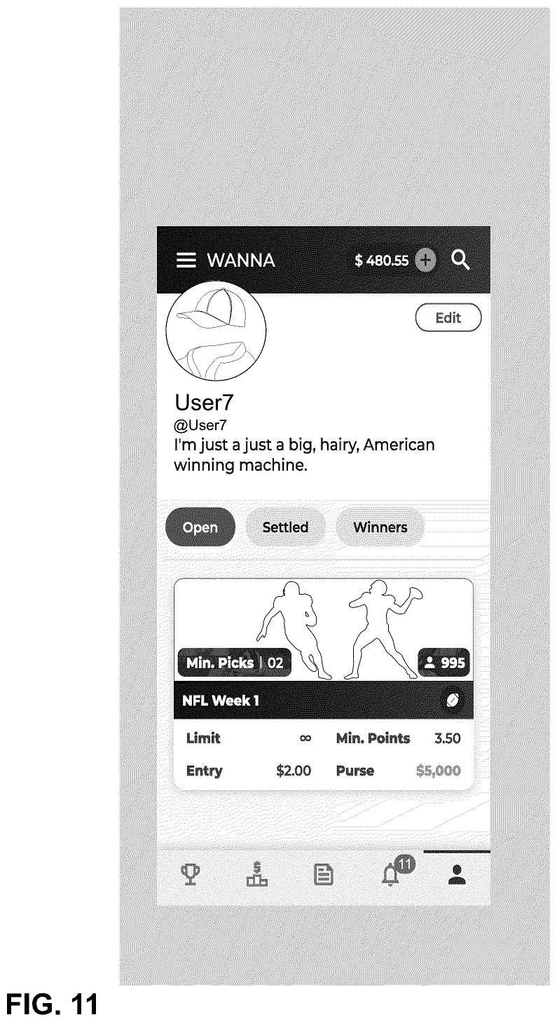

FIG. 11 is an example player profile screenshot, in accordance with certain example embodiments. In FIG. 11, a user avatar is provided, together with the player's name, “handle” (prefixed with an @ sign or the like), a brief description of the player, and items about the competitions and/or games with which the player is associated. The latter may be sorted by those that are open, settled, and/or won.

Based on the above, it will be appreciated that the platform may provide its own social networking functionality. In certain example embodiments, integration with external platforms may be enabled too. This may include, for example, using APIs or the like for integration with Facebook, X (formerly Twitter), Instagram, and/or the like. In some cases, items may be shared in or across these different social networks.

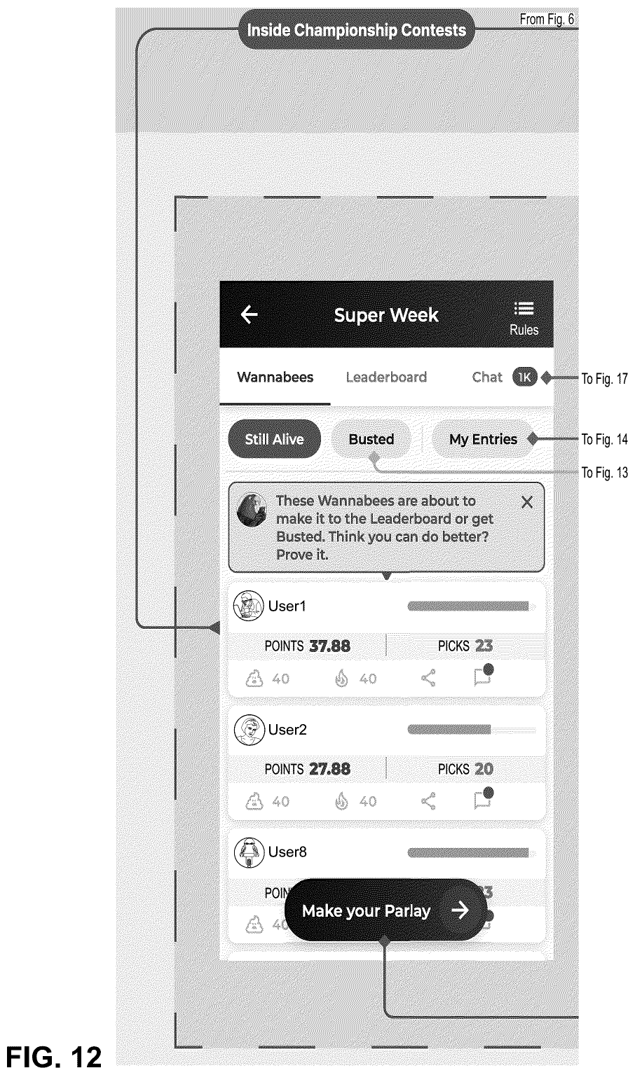

FIG. 12 is a screenshot enabling users to see and follow the progress of the games in the competition in real-time, in accordance with certain example embodiments. Each of the entries in the FIG. 12 example shows the player who created the associated game, the real-time points accrued, the number of building blocks selected, and a progress bar indicating the percentage of building blocks that have been resolved. A messaging system also enables users to like or dislike entries, share information, and post messages about them. Games can be filtered to show which are still alive (i.e., where no building block has been unsuccessful), those that have “busted” (i.e., where the game has one or more unsuccessful building blocks), and those games that belong to the user using the app (whether still alive or busted). As explained, in some instances, a competition may be defined so that a failure with respect to a single building block may cause a “bust” for the entire game. In other instances, a competition may be differently defined so as to permit a predefined number of failures before triggering a bust. Referring once again to FIG. 12, the player also can view the leaderboard for the competition and engage in chats related to the competition. In this example, the competition is called “Super Week,” and the rules of the competition are accessible via a menu icon in the upper-right corner.

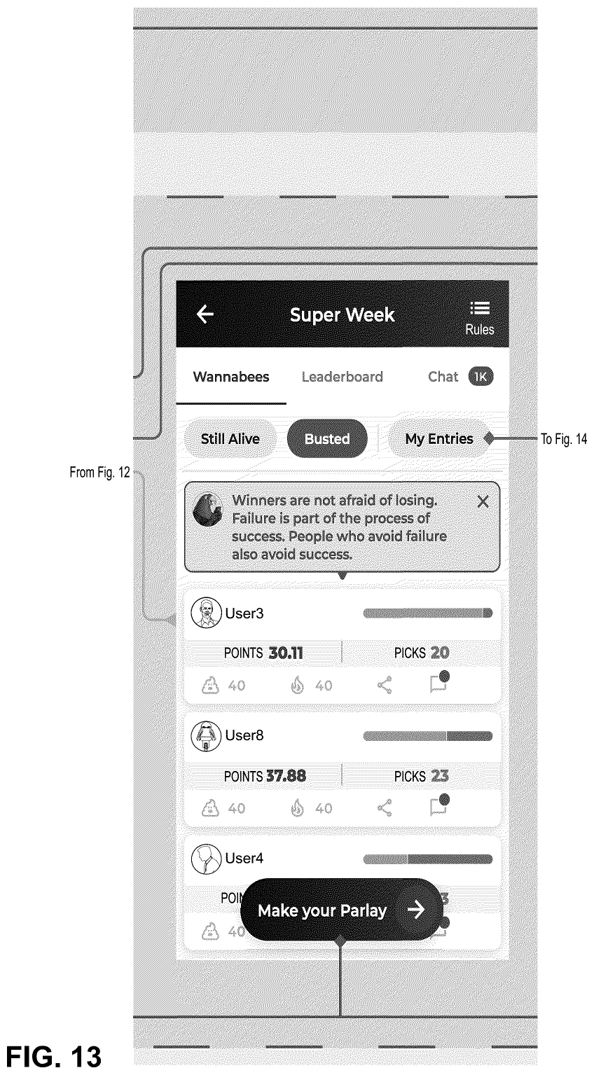

FIG. 13 shows those games that have suffered a loss with respect to one of the building blocks therein and thus according to the rules of this competition are “busted” (i.e., not eligible to win), in accordance with certain example embodiments. As indicated above, in certain implementations, rules may be set so that a single building block may cause a game to fail. In other cases, rules may be set so that a certain number of building block failures may cause a game to fail. In still other cases, rules may be set so that building block failures are allowed without completely voiding the game. In the latter two instances, games with failures may not count towards total point values for the games in the competition.

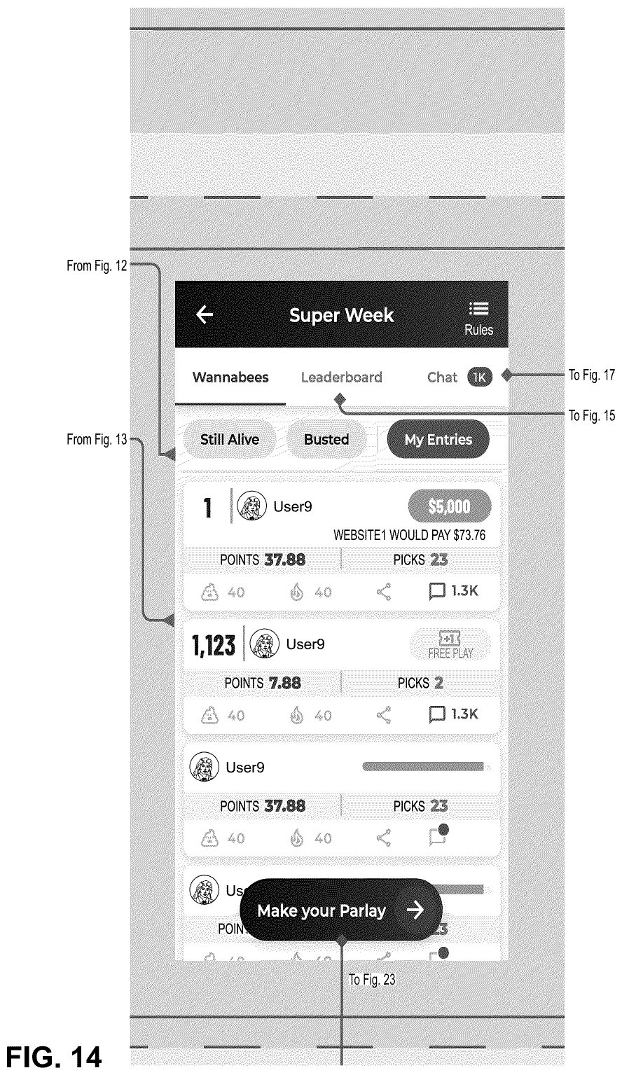

FIG. 14 shows those games that have been created by the player using the app, in accordance with certain example embodiments.

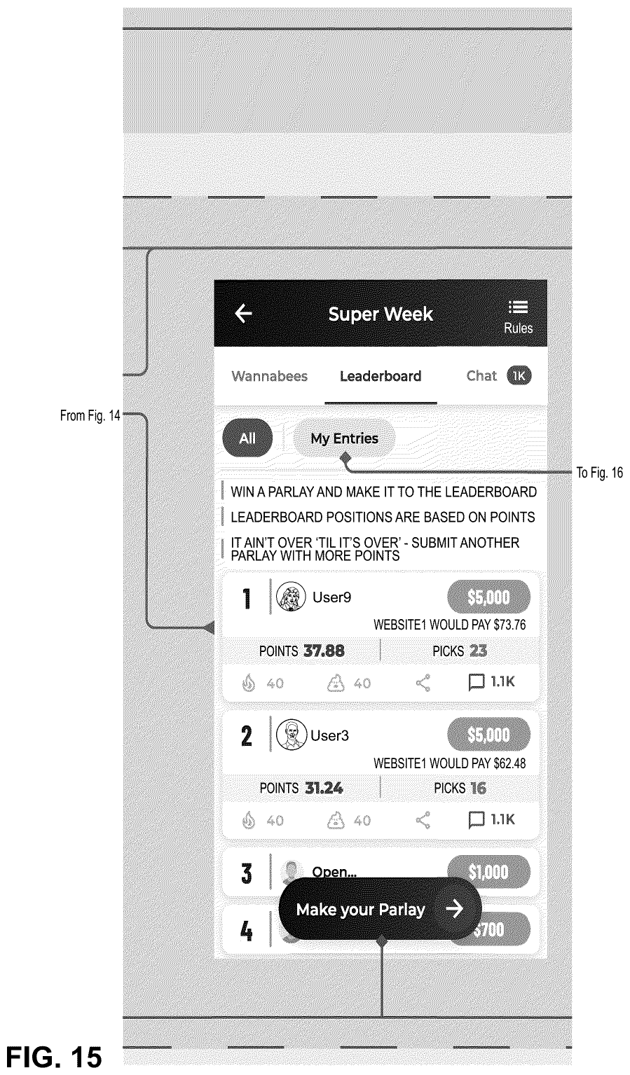

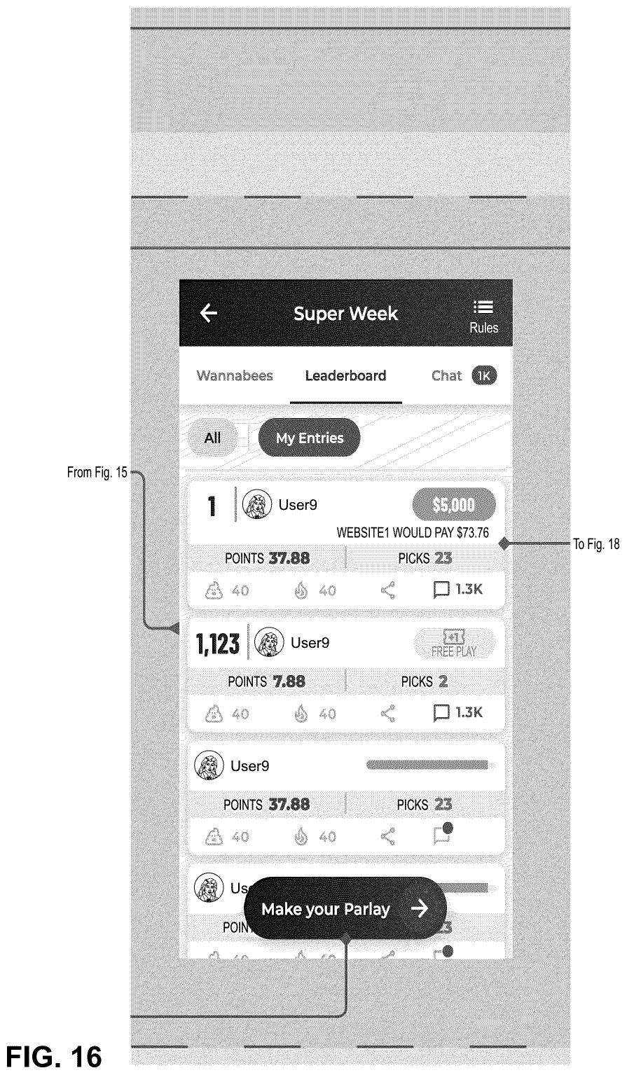

FIG. 15 is a screenshot showing a leaderboard for the competition, in accordance with certain example embodiments. The leaderboard in this example screenshot lists games based on calculated point values, from highest to lowest. The entries that are included may be, for example, all “live” games, all completed games, all games, or a certain number of any of the foregoing. Predetermined in-game or other awards may be provided based on the leaderboard. FIG. 16 is a screenshot of FIG. 15, filtered by the player's own entries, in accordance with certain example embodiments.

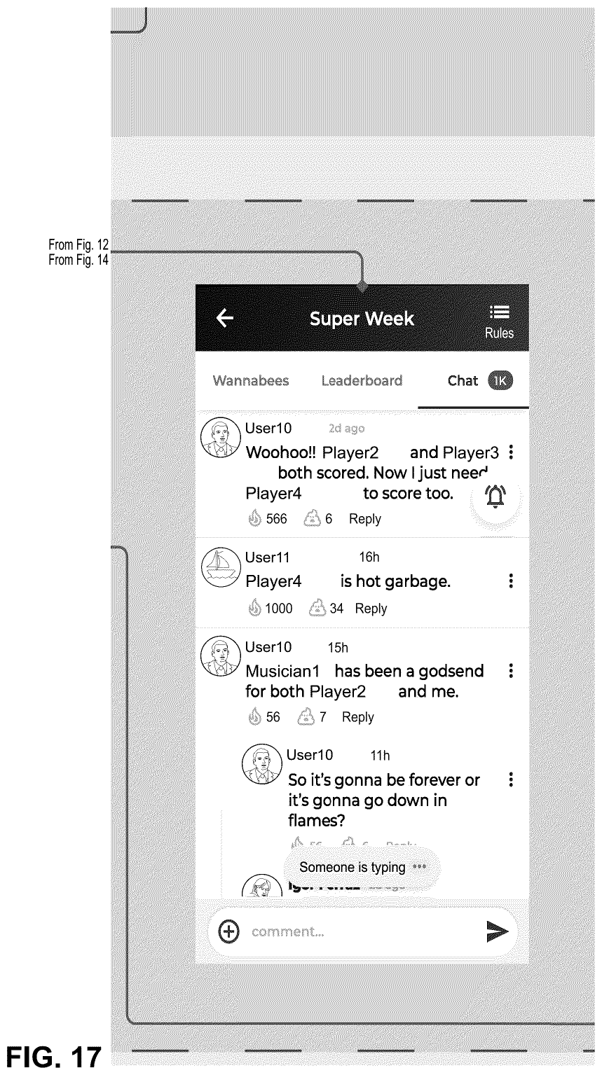

FIG. 17 is a screenshot of a chat tied to the competition, in accordance with certain example embodiments. The chat function enables players playing in the competition to banter back-and-forth about the competition, games in the competition, building blocks in the games, or something “off-topic” relative to the foregoing. The chat function may be moderated by the server system in certain example embodiments, e.g., so that messages are processed through the game management server 104 and can be reviewed by an admin user or admin team of the game manager server 104 in certain example embodiments.

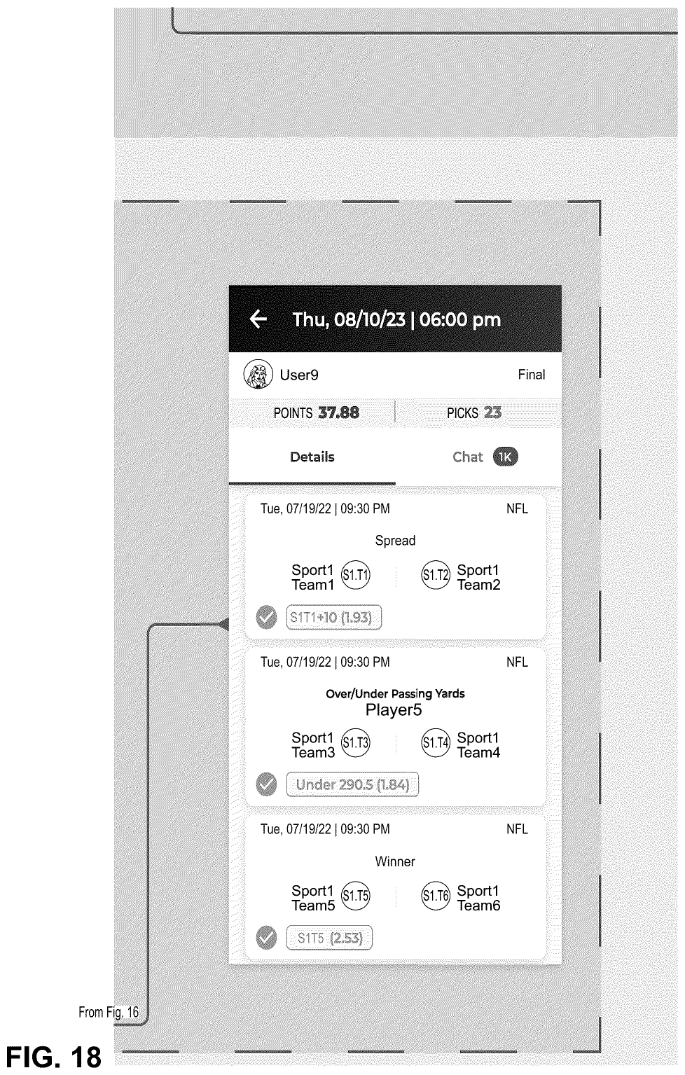

Selecting any of the entries, e.g., from FIG. 16, results in the FIG. 18 screenshot being displayed. In certain example embodiments, the FIG. 18 screenshot is a detailed page about the building blocks that comprise the game corresponding to the selected entry. The details of the building blocks are shown, which in this case include a display of the difficulty values, points earned, conditions associated with the building blocks, etc.

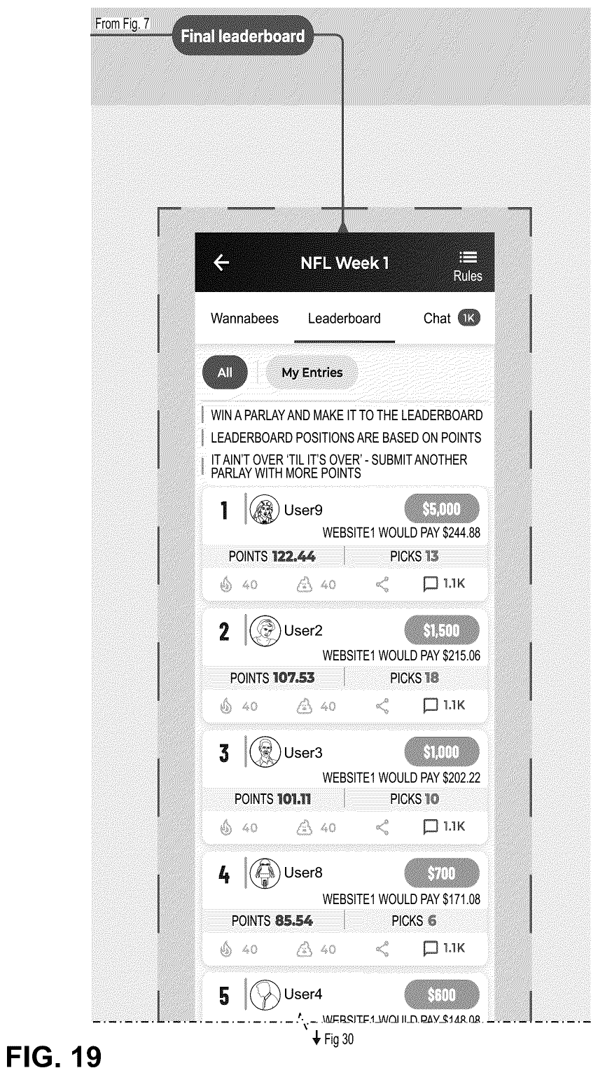

FIG. 19 shows the leaderboard for the “NFL Week 1” competition, in accordance with certain example embodiments. FIG. 19 is similar to FIG. 15, except that it applies to the overall results in this particular example competition. Example prize payouts are shown for the completed competition.

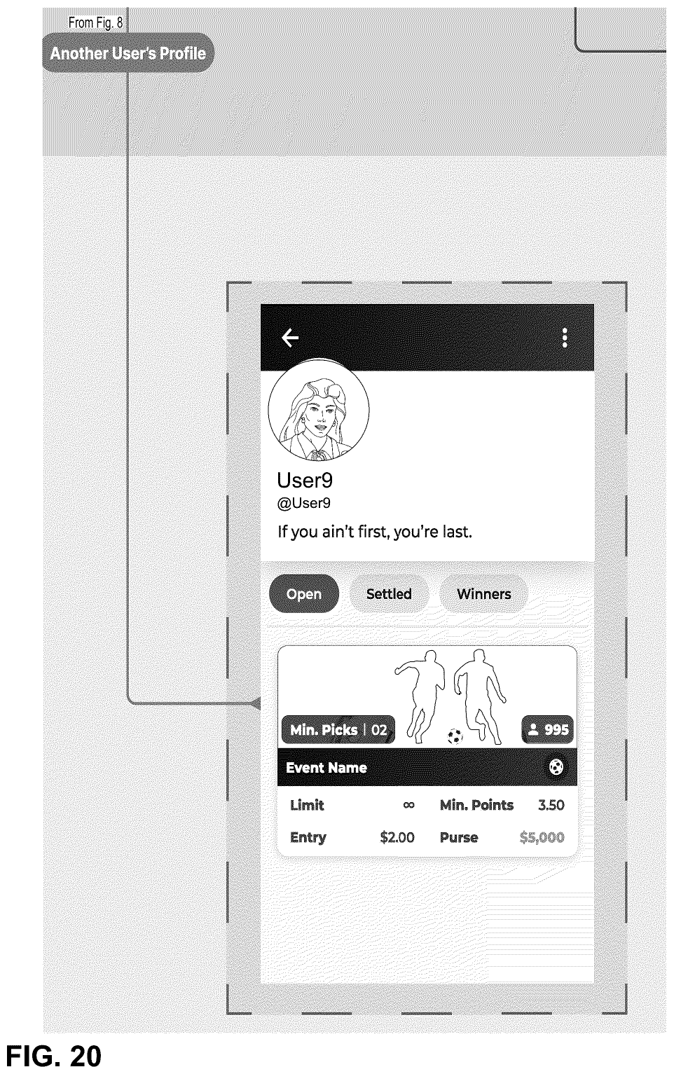

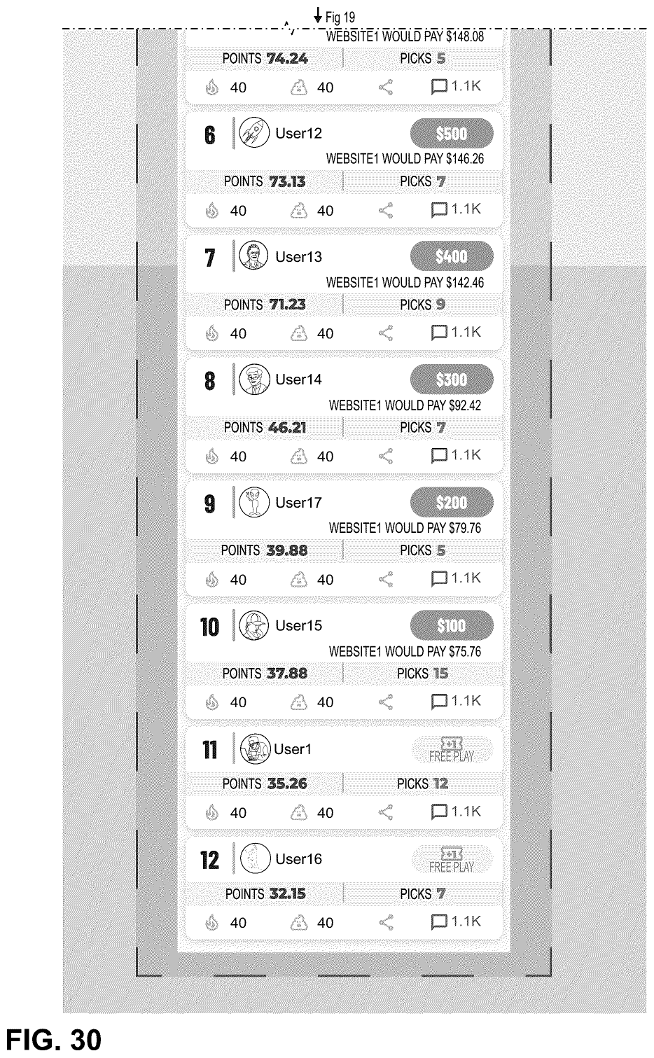

In certain example embodiments, all player profiles may be made public. In certain example embodiments, a player may designate certain parts of a profile to be public and certain parts to be private or restricted in some way (e.g., specifying that certain parts are accessible only to designated acquaintances). In this regard, FIG. 20 is an example view of a profile of another player different from the player logged in using the app on their own device, in accordance with certain example embodiments. The other player's details can be seen, including every competition in which that player is currently participating and every competition in which that player has participated in the past. Selecting a particular competition can be used to see that player's games, the building blocks associated with those games, etc. Filters can be applied to show competitions that are opened, settled, and/or that have been won by that particular player. The leaderboard from this example continues in FIG. 30.

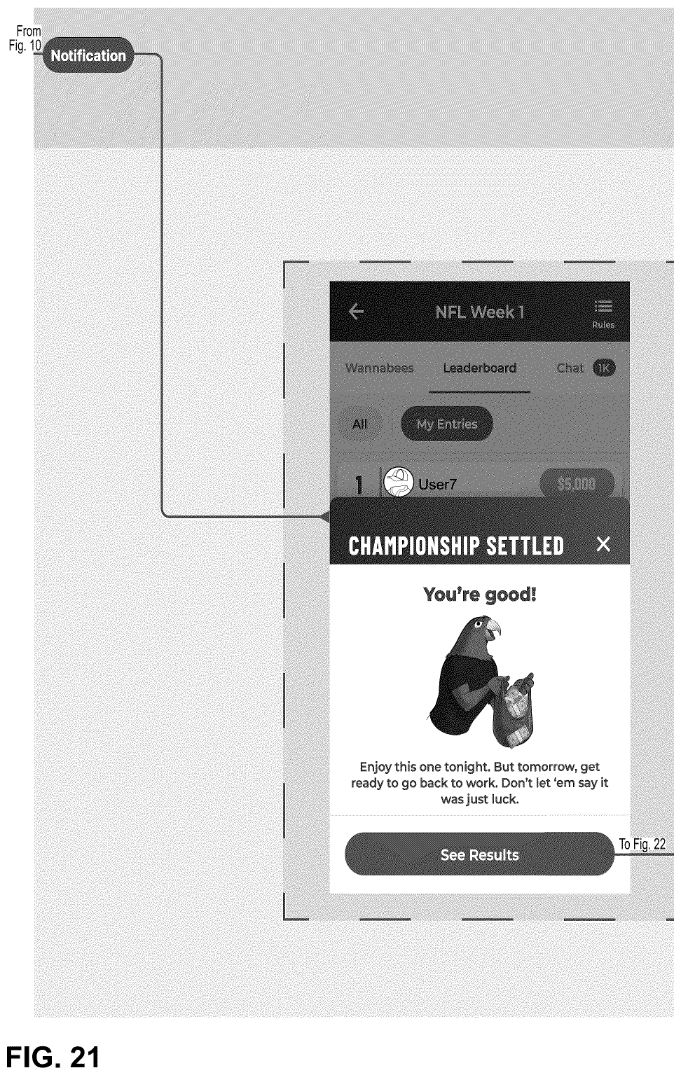

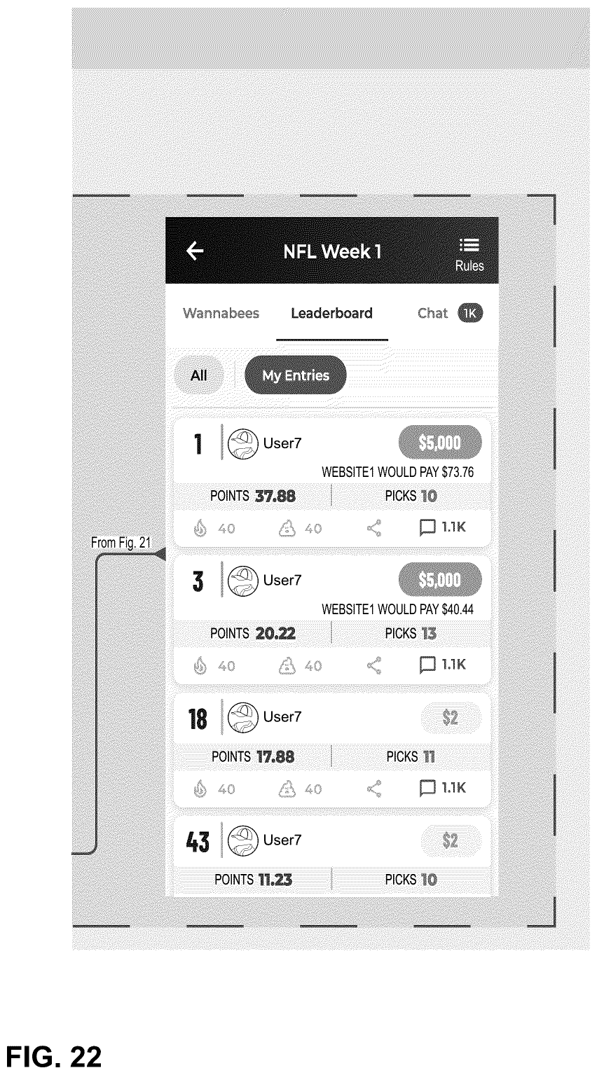

FIG. 21 is a screenshot of a notification that a competition has been completed, in accordance with certain example embodiments. The FIG. 21 example screenshot enables the player to access the results of the competition, as shown in the FIG. 22 example screenshot. That is, FIG. 22 is a screenshot with an example leaderboard for the “NFL Week 1” competition.

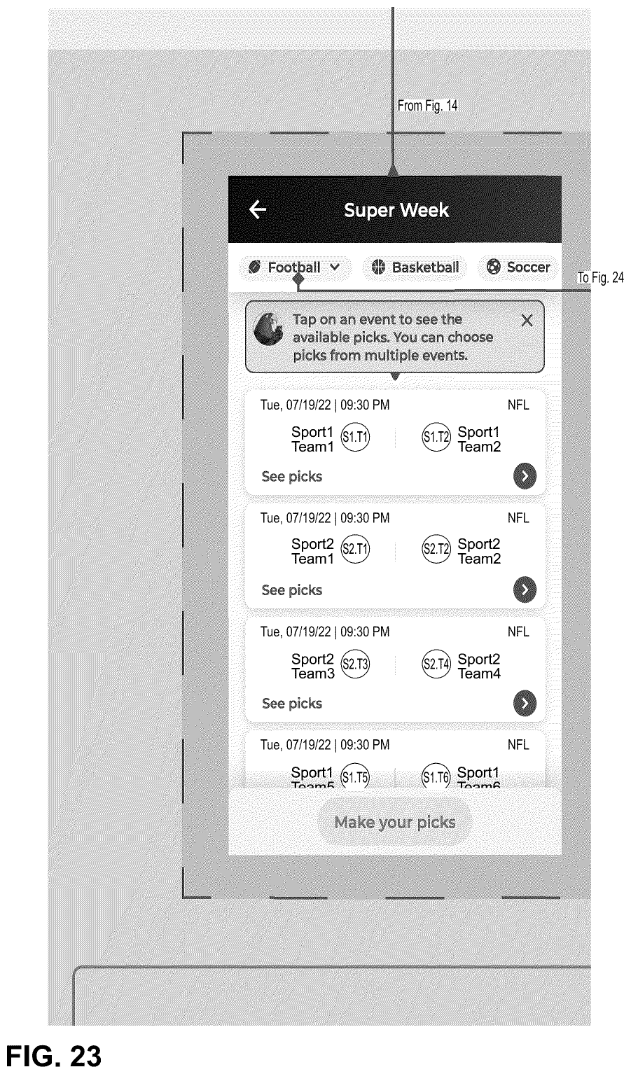

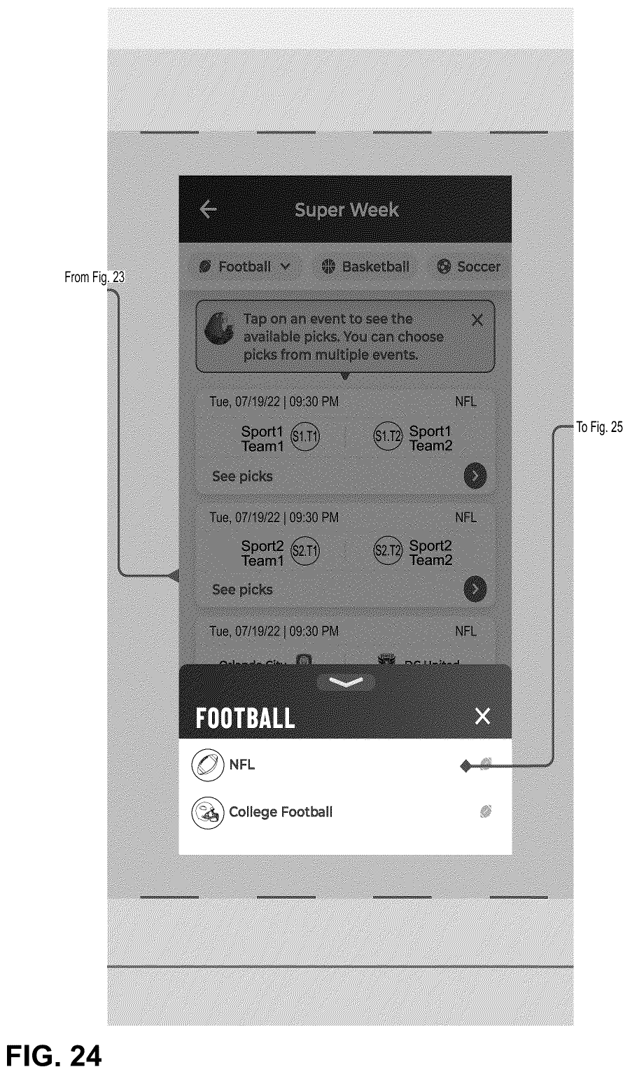

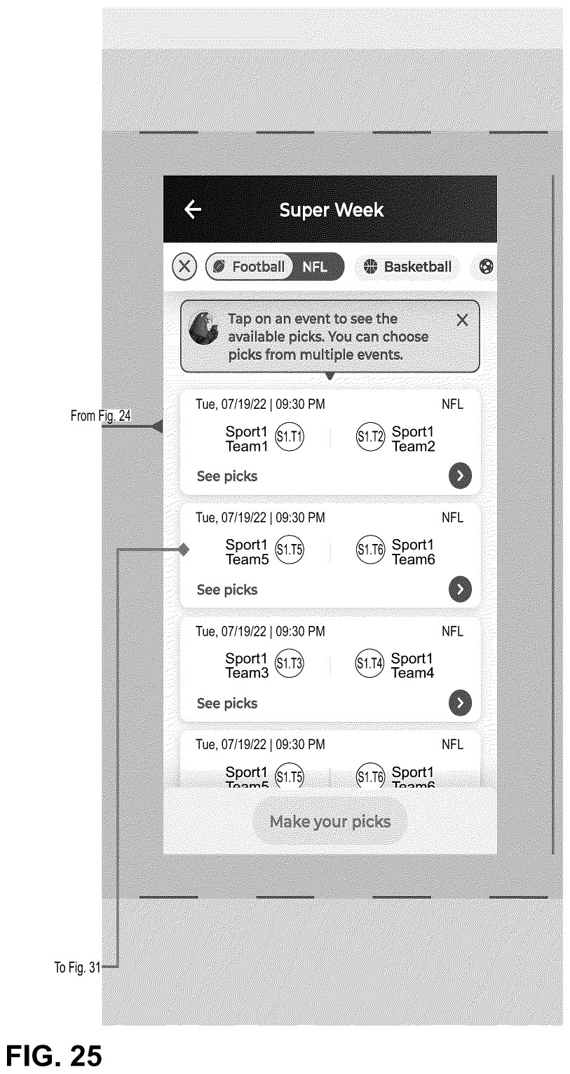

FIG. 23 is a screenshot showing how a game can be defined, in accordance with certain example embodiments. Depending on the competition, players can build their games by making predictions based on multiple different real-world sporting events in the same or different leagues. For example, in the “Super Week” example shown in FIG. 23, the player can select building blocks from football, basketball, and soccer events. The leagues from which building blocks can be selected may be specified as a part of the competition definition structure. Relational tables may be consulted to further narrow down options. For example, if the football option is selected in FIG. 23, then the FIG. 24 screen is shown, and the player can further narrow the scope of building blocks to be selected based on either NFL or college football related building blocks, as NFL and college football may be treated as children entries of a football parent entry in a relational or other database. FIG. 25 shows aspects of building blocks available for selection if the NFL option is selected in FIG. 24, in accordance with certain example embodiments. In the FIG. 25 example, the aspects of the building blocks are the various games being played. Basic information including which teams are playing and when the games are taking place is shown. Selecting an option brings up additional opportunities for building block customization, e.g., as described in greater detail below. In different example embodiments, different means of selecting events may be provided. For example, a player may be able to search for a specific conference, team, player, matchup, or the like.

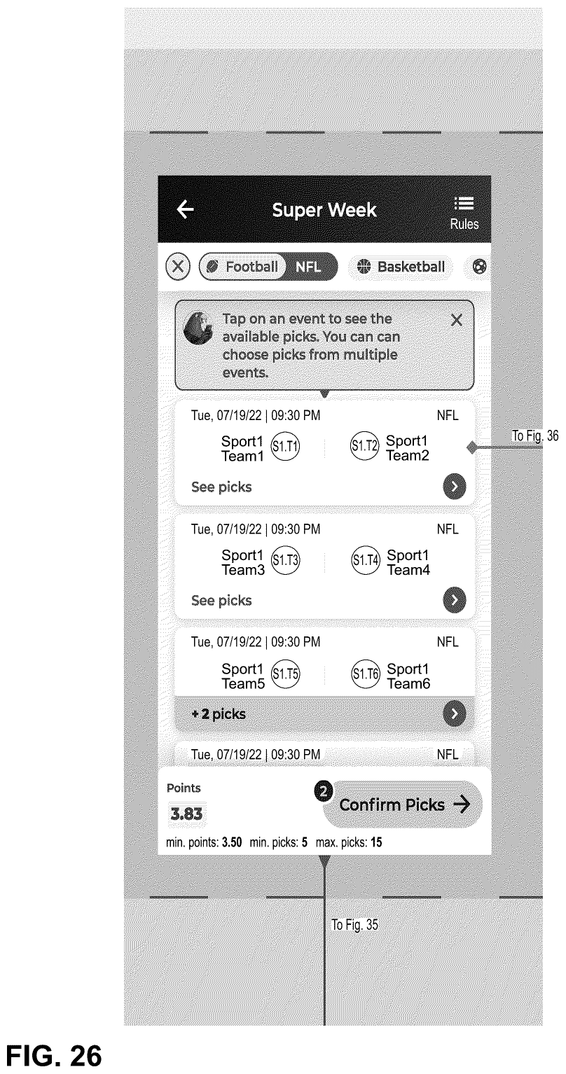

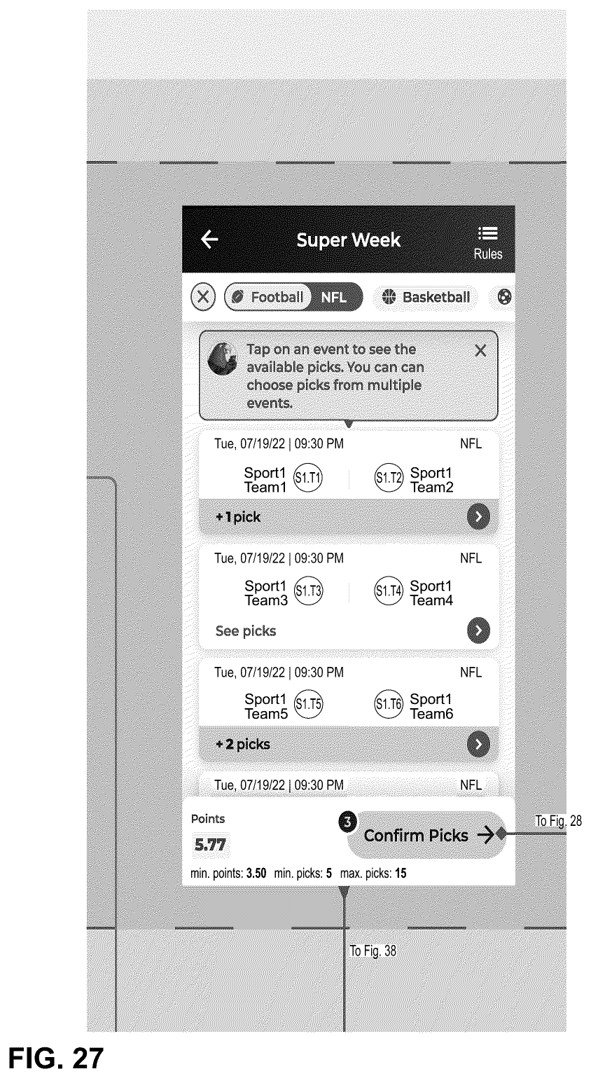

FIG. 26 is a screenshot showing two picks being made in connection with a particular event, and the player has an opportunity to confirm the selection, in accordance with certain example embodiments. FIG. 27 shows the two picks from FIG. 26, along with one additional pick made in connection with a different event, in accordance with certain example embodiments.

As more time passes, fewer and fewer real-life events may be available for selection in connection with an ongoing competition. For example, if a particular competition has four events per day and lasts for one week, then users will have 28 total events from which to select building blocks when the competition starts. However, if a player joins the competition on day 5, or on that day wants to start a new game, or wants to add to building blocks to an existing game, then only 12 events will be selectable. These latter two options may be enabled based on the rules of the competition in certain example embodiments.

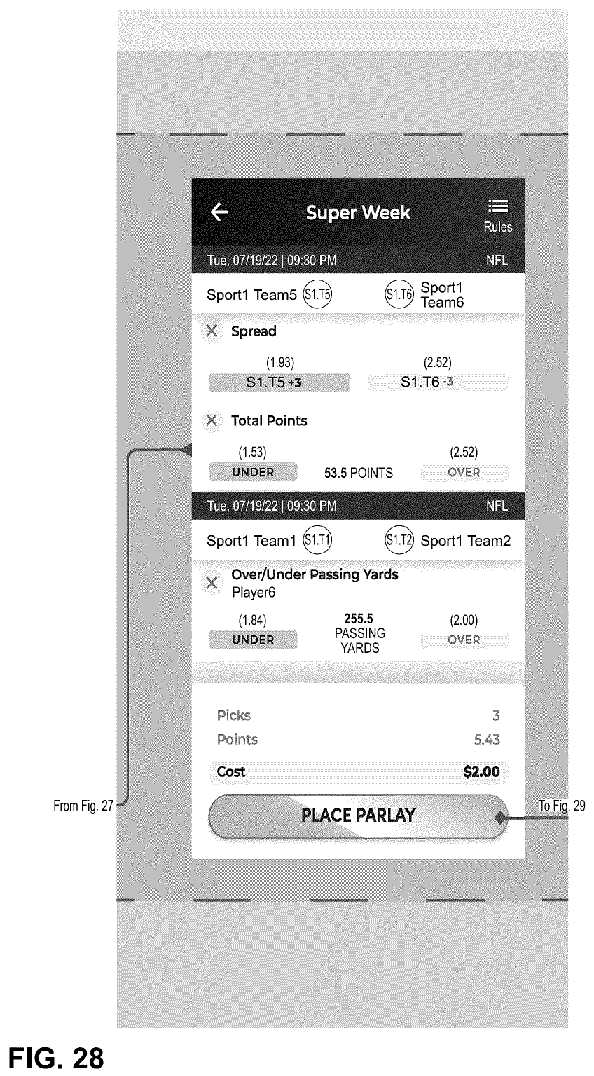

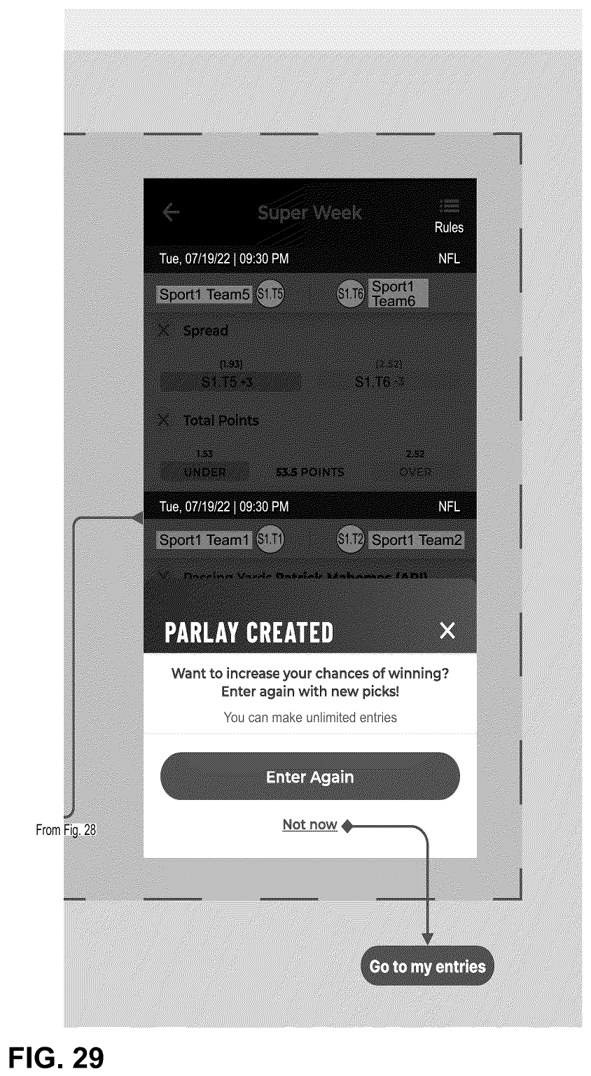

Once a set of selections is made and the game is ready to be committed, the player presses the button as shown in FIG. 26 or FIG. 27 to review those selections in connection with a final confirmation screen, in accordance with certain example embodiments. FIG. 28 is an example final confirmation screen that identifies the competition, as well as details regarding the building blocks for the game being defined, in accordance with certain example embodiments. From this, the game can be added to the competition by the player. FIG. 29 is a confirmation screen, which shows that the game has been added to the competition, and which allows the player the option to add another game to the competition (if allowable under the rules of the competition), view entries, or exit, in accordance with certain example embodiments.

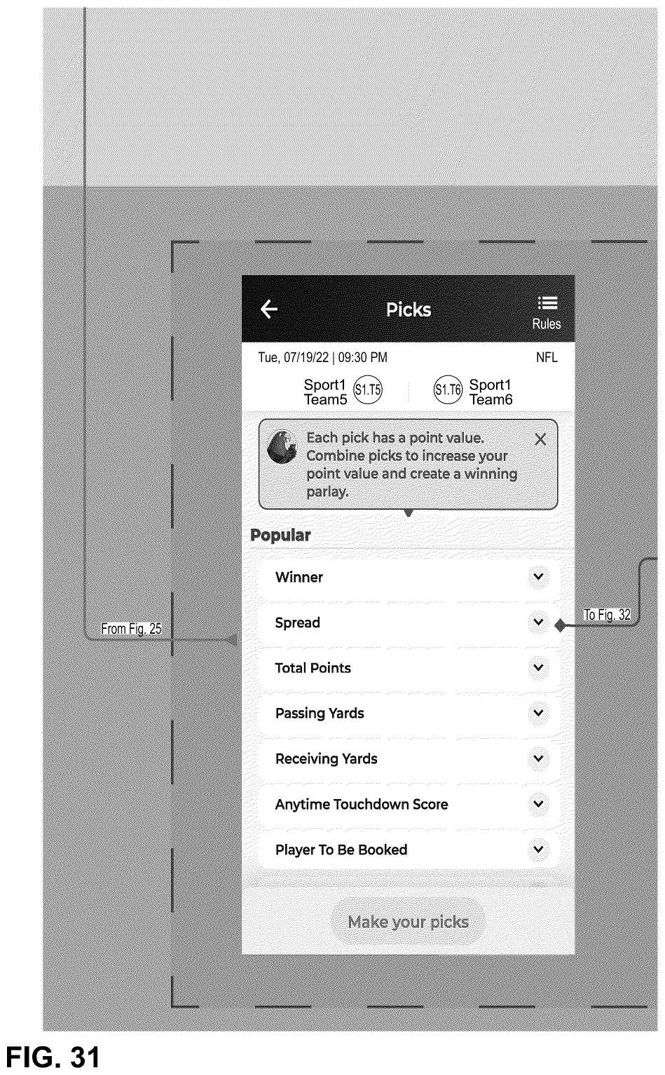

Each real-life sports event will have one or more different options for players to select from in selecting a building block when defining a game. In this regard, FIG. 31 is a screenshot with categories of options selectable in connection with the event selected in FIG. 25, in accordance with certain example embodiments. The categories include winner, spread (margin of victory), total points in the game, player achievements, team achievements, etc. Each of these categories may be further expanded and, where appropriate, further options may be selected for the building block.

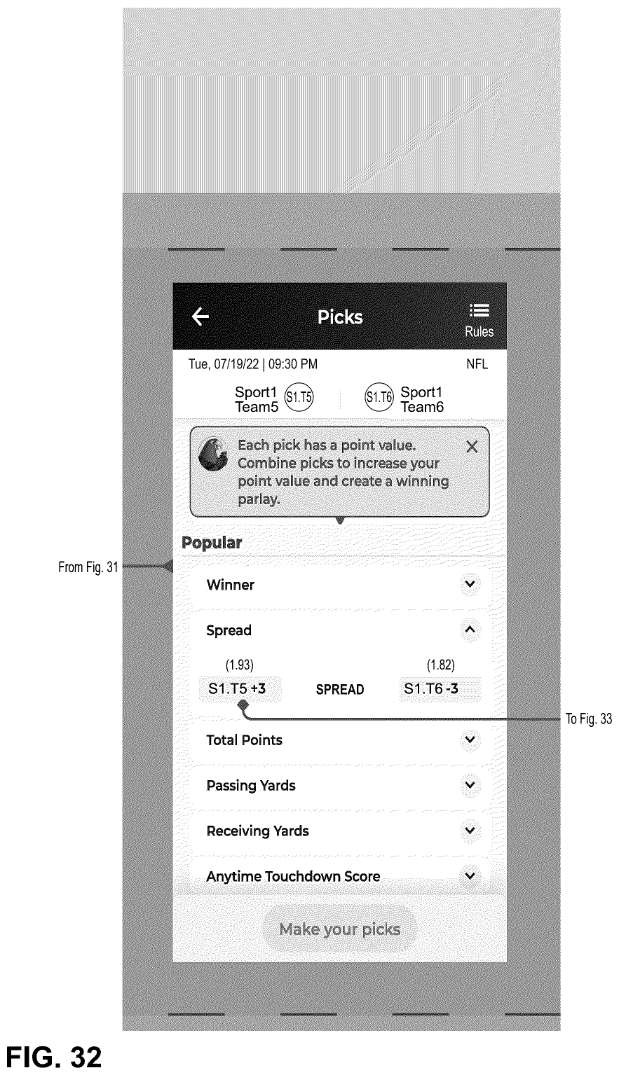

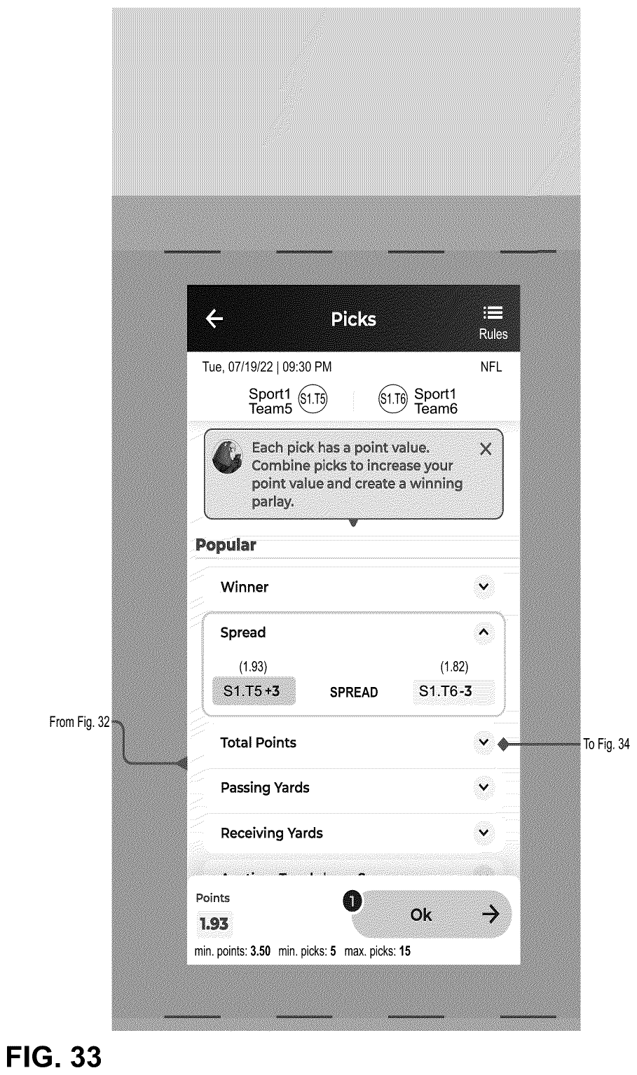

FIG. 32, for example, is a screenshot showing the spread (margin of victory) option from FIG. 31 being expanded, in accordance with certain example embodiments. In the FIG. 32 example screenshot, the spread is retrieved from an outside source, and the player defining the building block can bet with or against the spread. The difficulty level is shown. FIG. 33 shows a selection being made from one of the options in FIG. 32, in accordance with certain example embodiments.

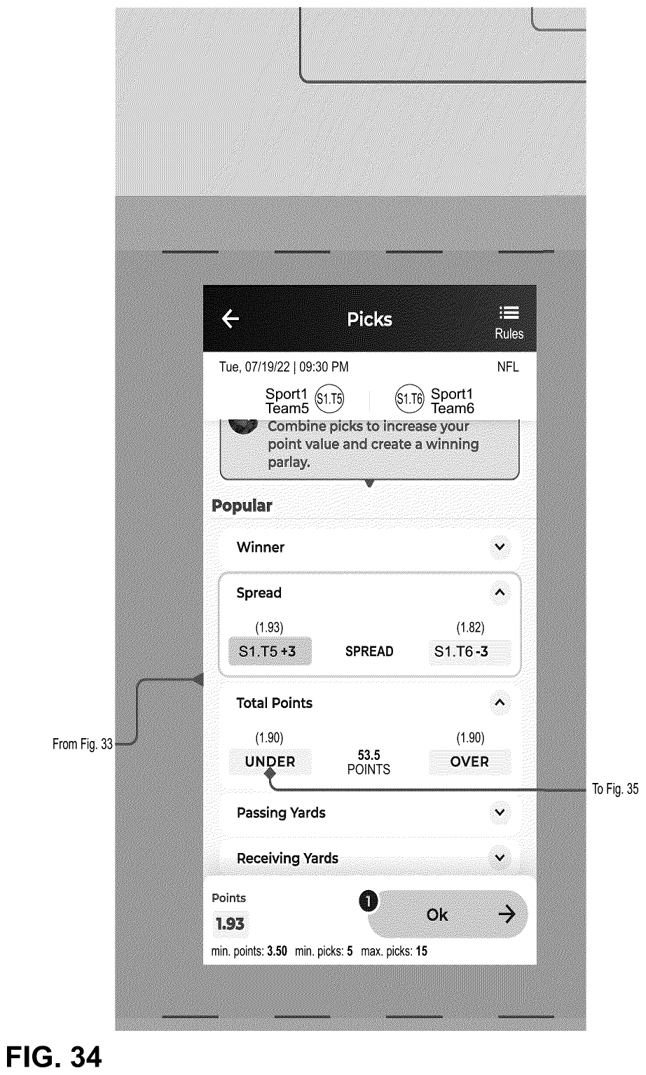

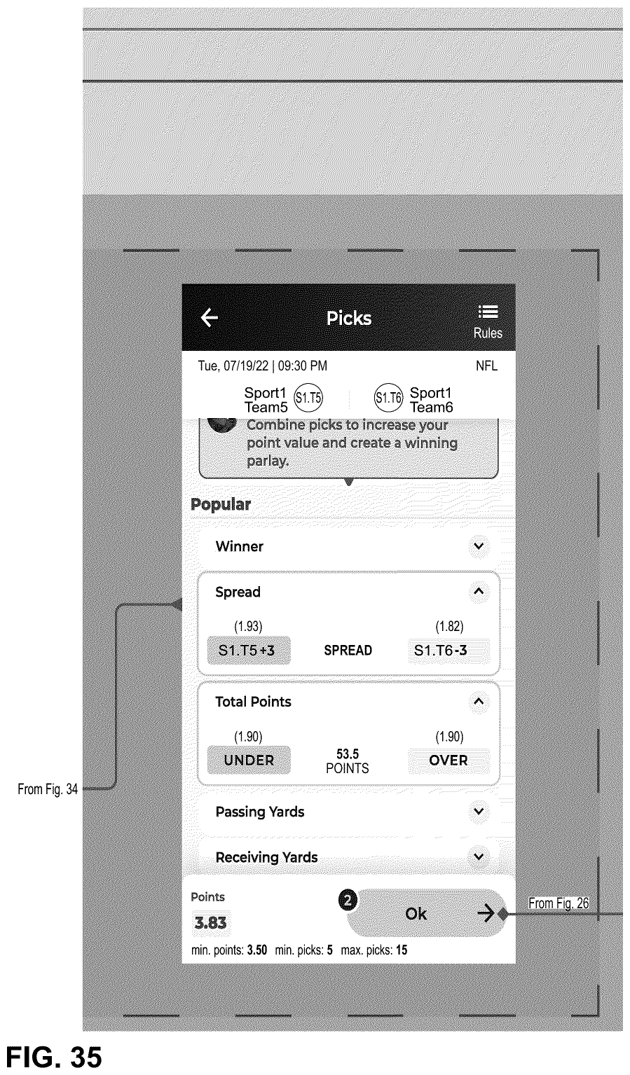

FIG. 34 is a screenshot showing options related to the total points, in accordance with certain example embodiments. Here, players can indicate whether they believe the given event will have a total number of points under or over a given number. Again, the difficulty level is specified. FIG. 35 shows the selection being made in connection with one of the options shown in FIG. 34, in accordance with certain example embodiments.

More generally, each option has a level of difficulty associated with it, and this level of difficulty may be translated into points for the player. The point value for a specific player may or may not be the same for different players, e.g., depending on the time that the various players see the options. In other words, difficulty values may change over time. A difficulty value may decrease, for example, if the majority of people are making the same prediction. When multiple people are making the same prediction, it becomes easier to predict and, therefore, the difficulty (and thus point value) is lower. The inverse also is true. In certain example embodiments, the difficulty level of each prediction is multiplied together to create an aggregate value of the game. The total possible value of a game may be displayed (e.g., as indicated in the lower right corner of FIG. 35.)

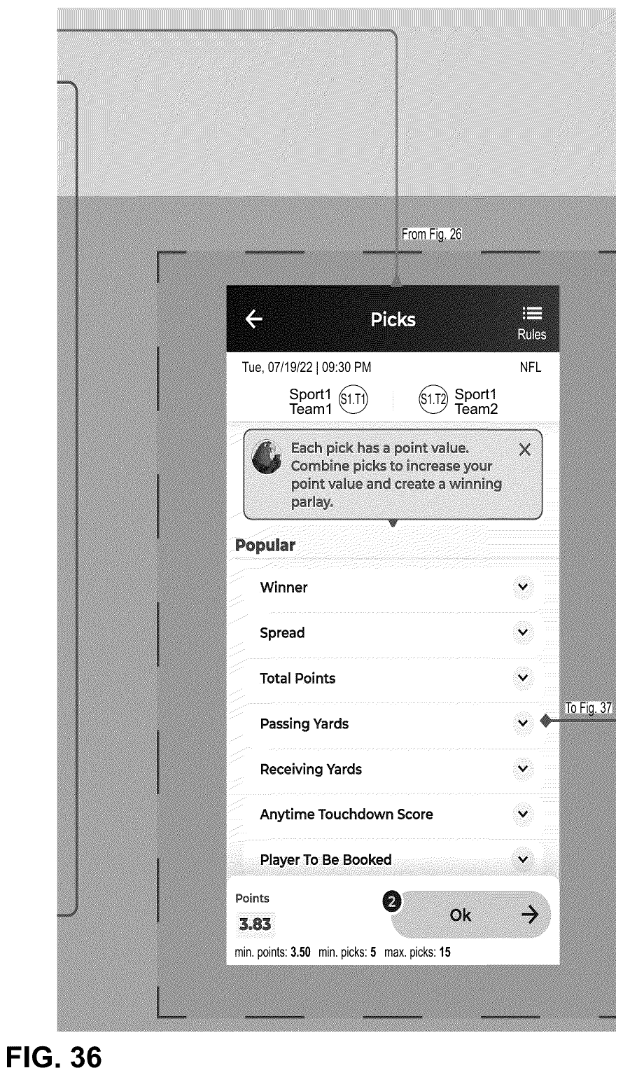

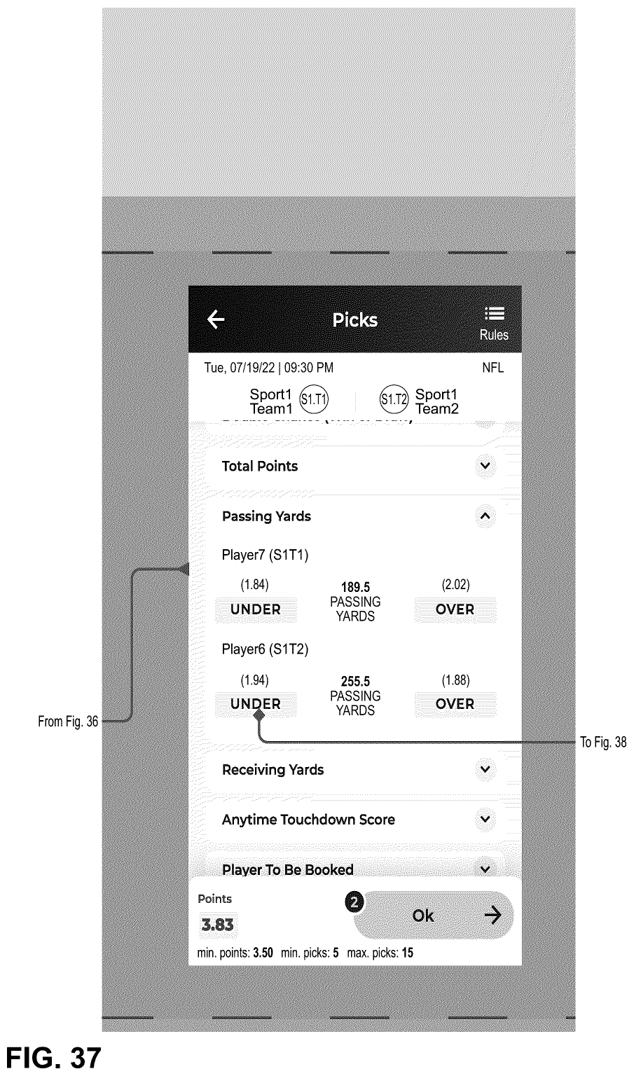

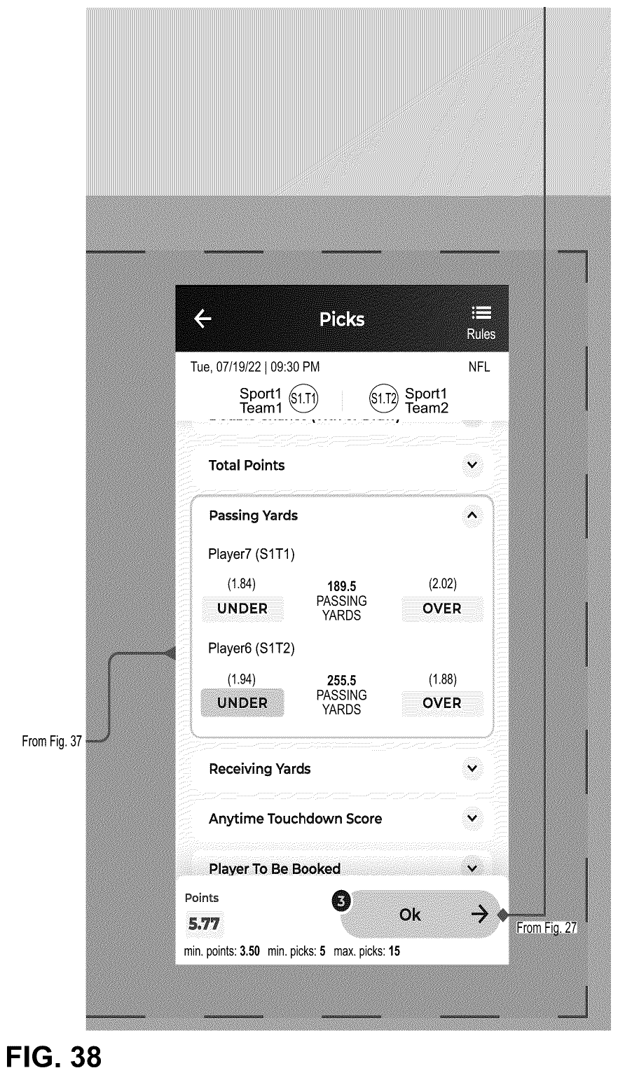

FIG. 36 is a screenshot showing that individual or team related metrics can be selected in specifying a building block of a game, in accordance with certain example embodiments. In this case, the selection in FIG. 36 brings up options as shown in the FIG. 37 example screenshot. Here, quarterback passing yards are provided for the quarterbacks of the opposing teams in the selected event, and players can select over or under options for one or both. FIG. 38 is a screenshot showing a selection being made for one of the quarterbacks, in accordance with certain example embodiments.

It will be appreciated that events in addition to or apart from sporting events may form building blocks in certain example embodiments.

As explained above, competitions may be defined to enable participation by a set number of players. In such instances, players compete against one another for a place on a leaderboard. In certain example embodiments, players can challenge one another or otherwise be matched (e.g., based on skill level, geography, or the like) to a given competition. In certain example embodiments, direct player-to-player challenges may be made.

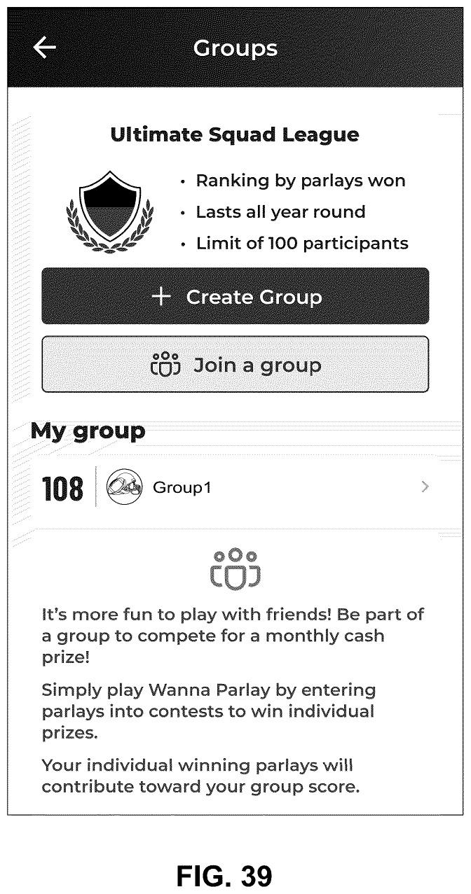

In still other cases, group games can be played. For example, a group challenge can be issued by one or more players already assigned to a group, by an already-formed group, or by one or more players deciding to form a group. The challenge can be issued against one or more other players already in one or more already-formed groups, one already-formed groups, or one or more other players not already in a group. In the case of a group game, the platform can judge a group of custom defined games against another group of custom defined games. The games are still built in the same way (e.g., with one or more predefined building blocks), however, a group owner or other person can invite members to a group for a group competition. FIGS. 39-46 are screenshots of an example group competition mode, in accordance with the example approach disclosed herein.

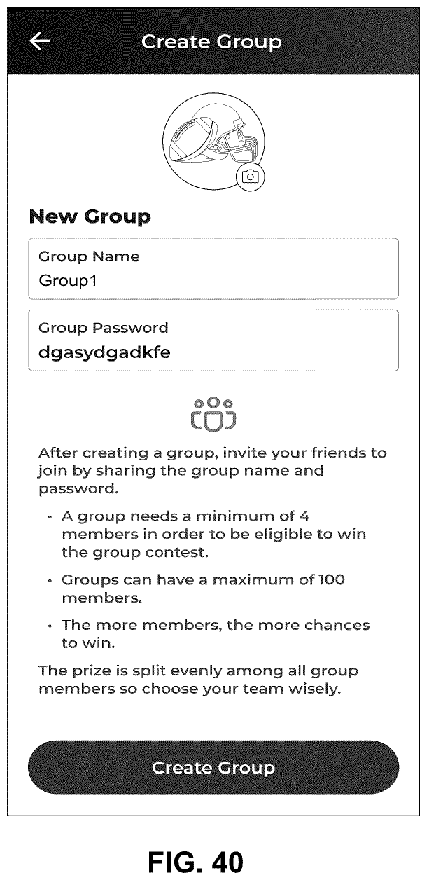

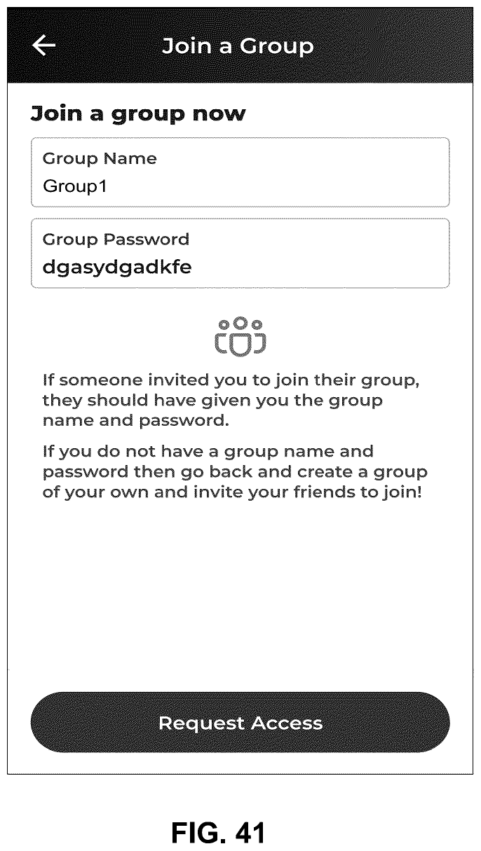

In certain example embodiments, each player may have the option to create a group or join an existing group. FIG. 39 is a screenshot enabling players to create or join a group, in accordance with certain example embodiments. The FIG. 39 example screenshot also shows the group(s) to which a logged in player belong(s) (which in this example is a group called “Group1”). FIG. 40 is a screenshot enabling a player to create a new group in accordance with certain example embodiments, and FIG. 41 is a screenshot enabling a player to join an existing group in accordance with certain example embodiments. When creating a group, the player can invite other players to join, e.g., by providing login credentials, a join code, or the like. When joining another group, the player can enter credentials that have been shared with the player, request permission to join, etc. The group size can be pre-set by a competition operator and/or group manager. For instance, in certain example embodiments, group size can be set to between 4 and 100 players. In other cases, different minimums and/or maximums may be set by the system competition operator, a group manager, or the like.

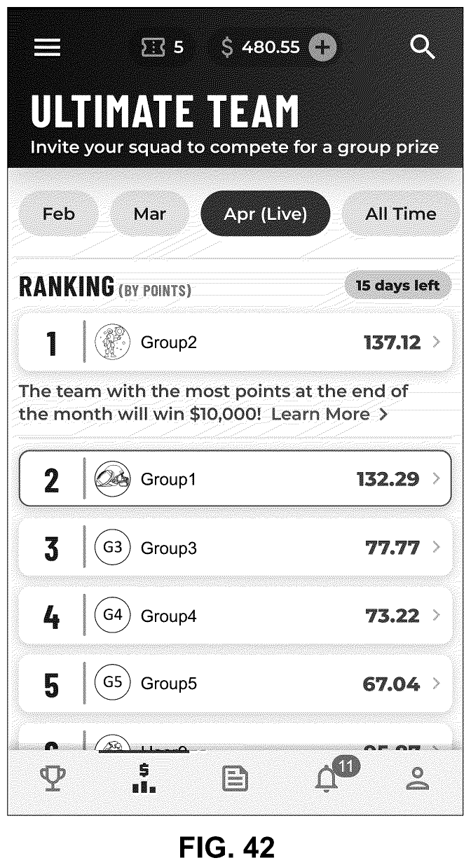

In some instances, the platform may host a group contest periodically (e.g., once a week, once a month, one per sports season, etc.). In some instances, players may host group contests. When a group contest is running, a leaderboard may be presented. FIG. 42 is a leaderboard for a group contest, in accordance with certain example embodiments. Similar to the leaderboards discussed above, the FIG. 42 example leaderboard shows some or all of the groups in a list ordered by points accrued at the time of the leaderboard is viewed. The group with the most points at the end of the month will win the group prize in some instances. In the FIG. 42 example, the amount of time left in the competition is displayed. In some instances, if the player is associated with a group not among the top groups displayed (e.g., in this case the top 5 displayed), that player's group nonetheless may be displayed at the bottom of the screen so that the player can check his/her group's status relative to the leaders.

In certain example embodiments, a group contest may be treated as a sub-contest of the main competitions hosted by the platform. In such cases, players cannot submit their games directly into the group contest. Rather, they may automatically participate in a group contest by simply belonging to a group and participating individually in platform-hosted competitions.

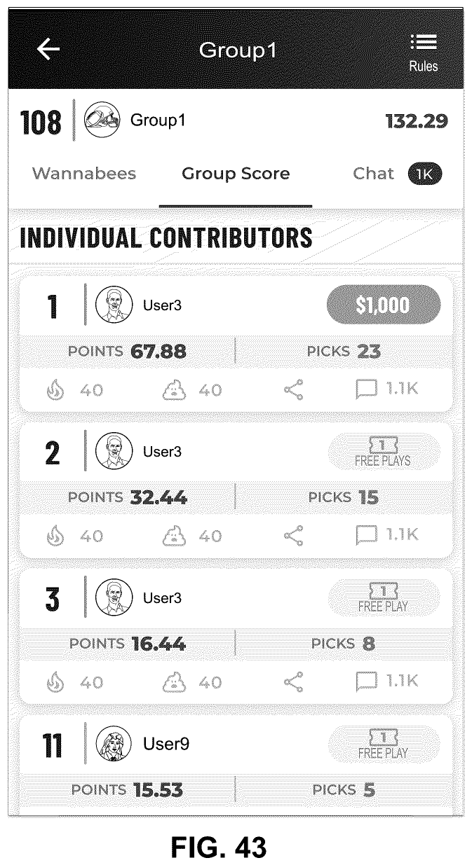

A group score is generated based on winning games from group members that were entered into competitions for the purpose of trying to win individual prizes. When a player selects a group from the FIG. 42 example screenshot, the top contributions may be displayed. FIG. 43, for example, is a leaderboard of the top games in one of the example groups shown in FIG. 42, in accordance with certain example embodiments. The player who contributed the game and the points earned are displayed in the FIG. 43 example. Similar to the above, if the player's game is not a top contributor to a group score, the player's contributions nonetheless may be shown at the bottom so that the player can have a feel for his/her relative contributions. In this case, the player (User9) in the selected group (Group1) has the eleventh-highest ranking in the group.

In certain example embodiments, a certain number of the winning games in a given group will be aggregated according to a certain formula. For example, the winning scores for all or some of the winning games in a given group will be aggregated according to a certain formula. The number may be the top 3, 5, 10, 20, etc., games. The formula may be a simple formula adding the scores of the top winning games in certain example embodiments.

In certain example embodiments, a given player can contribute multiple games, and multiple ones of these games may win in the sense that they might not go bust. In certain example embodiments, the number of winning games that a player can contribute to a final score may be capped (e.g., at 1, 3, 5, or some other number), which may in some sense help promote a feeling of group effort or the like. For example, if a player defines games that earn the five top scores in a given group but the group rules state that a winner can contribute only three entries towards a total of 10 top scores, then the top three scores for that player will be taken, and scores from other players will be used to “round out” the other seven contributions for the group score.

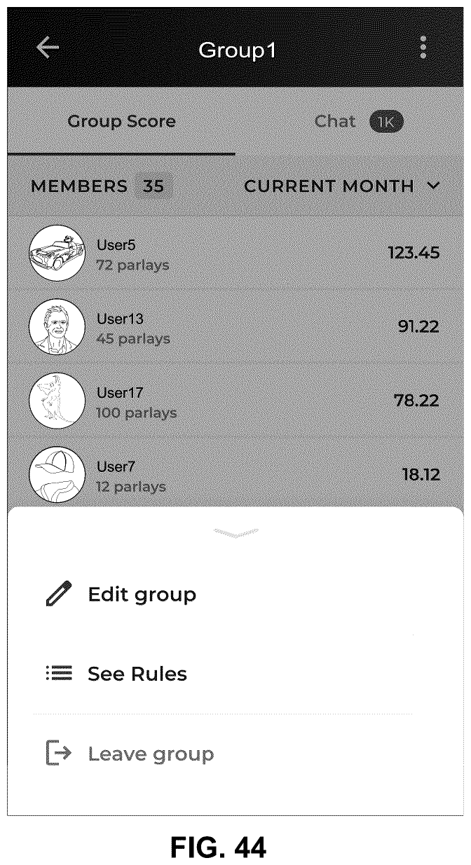

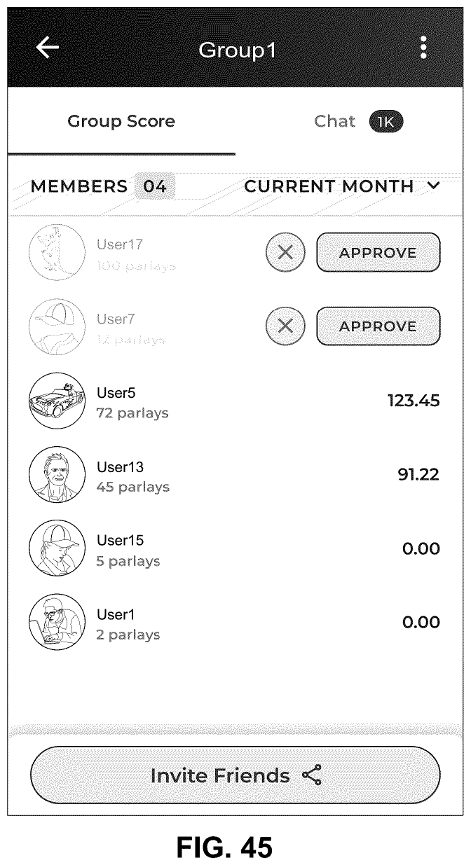

Creators of groups have the ability to edit the group information, remove members, bestow administrator permissions, and accept or reject requesting members. FIG. 44 is a screenshot showing a group edit screen, in accordance with certain example embodiments. FIG. 45 is a screenshot via which a group creator can allow a player who has requested membership in the group to join the group, in accordance with certain example embodiments. In certain example embodiments, creators of groups are able to edit group information (e.g., name, password or join code, etc.), add new members, remove members, give admin permissions, accept or reject requesting members, etc.

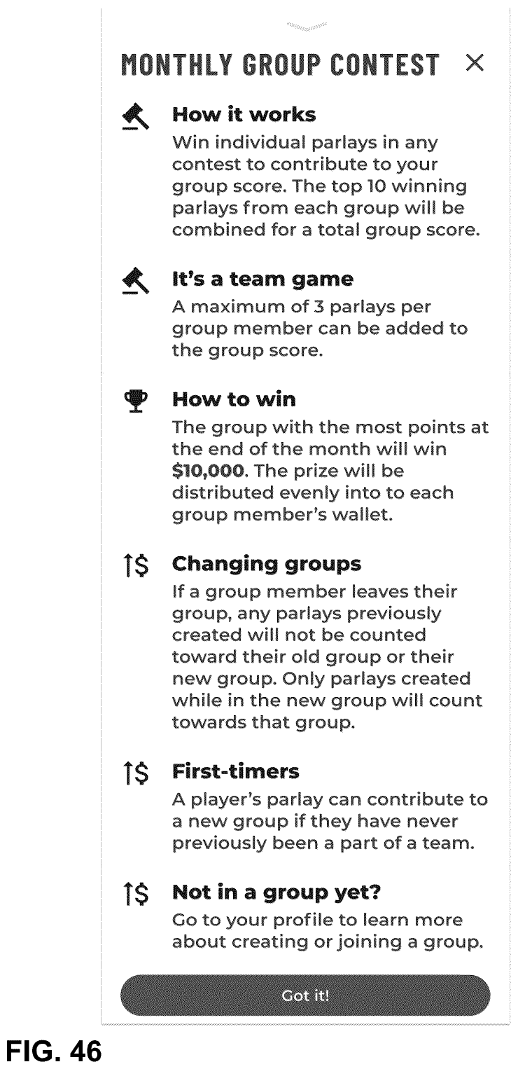

FIG. 46 is a screenshot with example rules for a group competition, in accordance with certain example embodiment. The FIG. 46 example screenshot includes sample rules, and these rules may differ in different example embodiments.

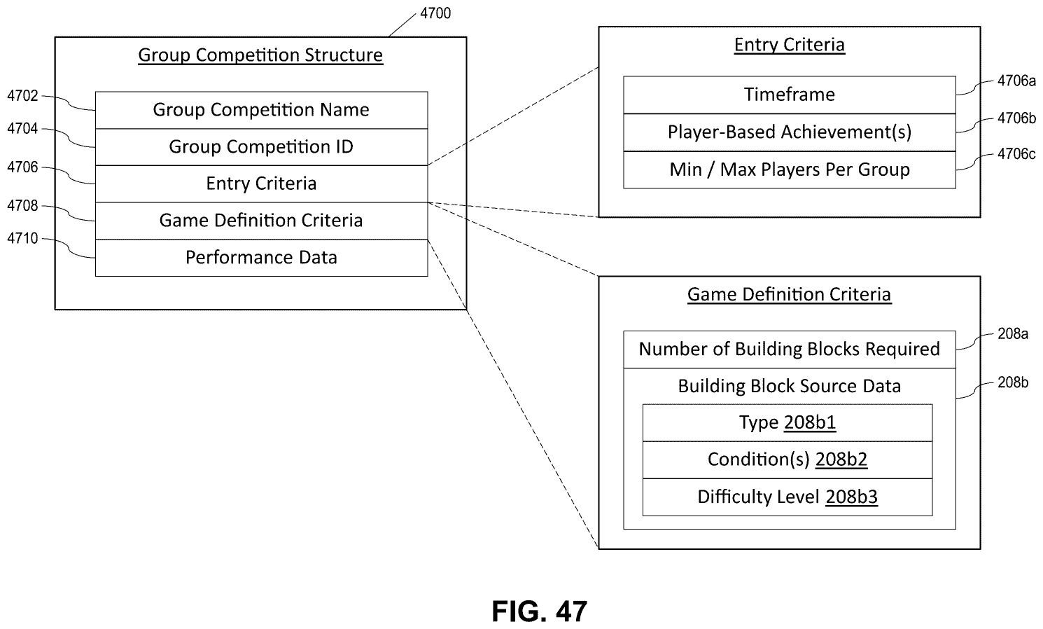

FIG. 47 is an example game server-side data structure 4700 that may be used to define a group competition in accordance with certain example embodiments. FIG. 47 is somewhat similar to FIG. 2, as the structure 4700 includes at least some similar fields compared to the game server-side data structure 200. For example, the group competition structure 4700 includes a group competition name 4702 and a group competition identifier 4704, together with entry criteria 4706, game definition criteria 4708, and performance data 4710. As multiple group competitions may be run concurrently and/or sequentially by the game management server 104, multiple such structures may be stored in the area shown in FIG. 1 (e.g., the competition definitions 118 of the memory 108 in the game management server 104).

The group competition name 4702 may be provided by the authorized party. The group competition identifier 4704 may be unique for the particular group competition represented by the data structure 4700. Entry criteria 4706 may include, for example, a timeframe definition area 4706a and player-based achievement(s) definition area 4706b that players need to achieve. With regard to the timeframe definition area 4706a, a group competition may take place over a predefined time period (e.g., a certain number of weeks, days, hours, until a player reaches a predefined score, until all players have lost except for one, and/or the like). Enrollment in the group competition by users may be possible for some or all of that time period. For example, enrollment in a given group competition may be possible at any point before a defined competition start time, within a certain predefined time window, at any point before the group competition ends, etc. Details of the group competition's length and/or enrollment times may be stored in the timeframe definition area 4706a. As above, a player may need to satisfy some player-based achievements before entering into the group competition. The entry criteria 4706 also may include minimum and/or maximum player information 4706c. For example, a group may not be considered fully formed and able to participate in the associated group competition unless/until it has the minimum number of players. Other entry criteria may relate to the maximum number of games a user can submit, how scores are to be calculated, whether there is a limit on how many high scores a single player can contribute to an overall group score, etc.

The game definition criteria 4708 is similar to the game definition criteria 208, e.g., in terms of what is it, how it can be retrieved, etc. Therefore, like reference numerals are used.

Performance data 4710 may include how well groups and/or players are performing for the group competition. It may be updated in real-time in certain example embodiments, e.g., if some events take place during the length of time that in which the group competition is running.

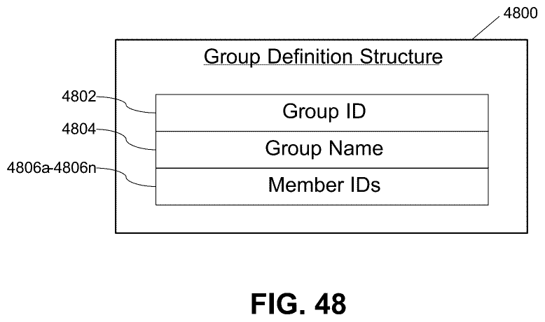

FIG. 48 is an example game server-side data structure that may be used to define a group, in accordance with certain example embodiments. This group definition structure 4800 includes a group identifier 4802 and a group name 4804. It also may have other information associated with it such as, for example, password or join code. The players who are members of the group represented by the group definition structure 4800 are identified with member identifiers 4806a-4806n. The member identifiers 4806a-4806n align with the player identifiers (e.g., player identifier 402 in the FIG. 4 game definition structure 400). Therefore, a group defined by the group definition structure 4800 includes at least a reference to player information as well as the games defined by the players in the group. In certain example embodiments, this information may be linked to from, or included with, the group definition structure itself. The group definition structure 4800 also may identify a forming group member, one or more administrators of the group, etc. The member identifier information may be augmented to store this information in certain example embodiments.

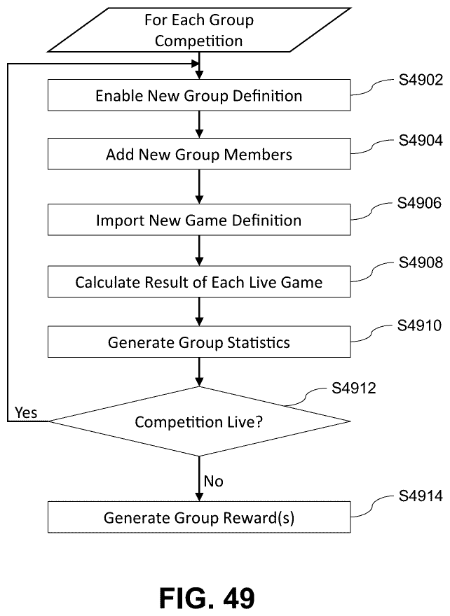

FIG. 49 is a flowchart providing an example of how a group competition can be run, in accordance with certain example embodiments. For each group competition, new group definition is enabled in step S4902. As noted above, in certain example embodiments, groups can be generated while a competition is being run. In certain example embodiments, groups may need to be generated in advance of the competition actually starting. In step S4904, new group members are added to the groups. As indicated above, players may be invited by an admin or other user, or they request to join a group. A player joining a group thus may have that player's games imported into or otherwise associated with the corresponding group in step S4906. As above, depending on the rules of the group competition, players may be able to generate new games while the group competition is taking place, or they may be required to set their games in advance.

In step S4908, the results of the live games are calculated in step S4908. Group statistics are generated in step S4910. A determination is made as to whether the group competition is still “live” in step S4912, if so, then the process loops back to step S4902, step S4906, or step S4908, e.g., depending on the rules of the game (and whether new groups/games are allowed). Once the competition is no longer live, group rewards are generated in step S4914.

Based on the foregoing, then, it will be appreciated that a group competition is defined for a number of players. Each of the players is assigned to at least one of two or more groups that participate in the group competition, so that each group has at least two of the players assigned thereto. In other words, in certain example embodiments, each player is assigned to at least one group, and in some instances, a player may belong to multiple groups in a single group competition. Moreover, a valid group in some instances may require at least two different players to be assigned thereto. In certain example embodiments, a player may belong to only one group per group competition (but may or may not belong to other groups in other group competitions).

Each player is able to use a graphical user interface (GUI) to define a game to be played for that player in connection with the defined group competition. Each of the defined games includes at least one building block selected by the player that defined the respective game using the GUI. Depending on the rules of the group competition, a given player may be required to select more than one (e.g., at least a predetermined number of) building blocks in order to generate a valid game. The GUI is customized for the group competition. Each of the building blocks has a difficulty level associated therewith. The games are differently definable by the players such that different numbers and types of building blocks are selectable by the players in defining the respective games, different building blocks are associated with different competitive events, and different players can select the same or different building blocks in defining their respective games.

For each player, a value is calculated based on the difficulty level(s) associated with the building block(s) in the game defined by the respective player. The values may be calculated in accordance with a predefined formula and the predefined formula may be defined such that the player having selected the most building blocks will not necessarily have the highest possible values. For example, the values may be calculated by combining the difficulty levels associated with each building block. Furthermore, as above, a determination may be made as to whether each player has been unsuccessful with respect to any of the building blocks in the games that the respective players defined. In certain example embodiments, for each player that has been unsuccessful with respect to any of the building blocks in the games that the respective players defined, values may not be calculated, and/or are may not be considered in the determining of the intermediate result set.

And for each group, an intermediate result set is determined by comparing the calculated values for at least some of the players in the respective group, with the intermediate result set for the respective group representing a respective list and identifying at least some of the calculated values and/or the players associated therewith. Up to a predetermined number of entries is selected from the respective list that represents the intermediate result set. A respective group result is determined based on the selected entries. In certain example embodiments, the group result may be calculated based on another predetermined formula. For example, the top X scores may simply be added together. As another example, the top X scores may be averaged. Other techniques also are possible.

In certain example embodiments, for each group, the entries that are selected from the respective list that represents the intermediate result set may be the entries having the corresponding highest calculated values, e.g., so that up to a predetermined number of entries are selected. But in some instances, the rules may specify that no player can contribute more than a predetermined number of player entries. Assume, for example, that the intermediate result set for a given group has five non-zero results, the group competition specifies that the three highest calculated values are to be combined in connection with the generating of an individual group result, and no single player can contribute more than two scores to the individual group result. Assume further that player 1 has the top three scores, player 2 has the fourth highest score, and player 3 has the fifth highest score. In this situation, the top two scores from player 1 and the score from player 2 would be used to determine the group result.

A group result set is determined by comparing the respective group results, and a first output screen is generated for display (e.g., via the GUI) based on the group result set. For instance, the first output screen may be generated to identify the groups having the highest determined group results, based on the group result set, such that up to a predetermined number of groups may be identified in the first output screen. In certain example embodiments, when a given player accesses the first output screen, the first output screen may be generated to identify the group(s) to which the given player is assigned and to include the group result(s) associated therewith.

In certain example embodiments, a second output screen may be generated for display, e.g., with the second output screen being generated responsive to a given user selecting a given group in the group competition. The second output screen may be generated to identify the players having the highest calculated scores for the given group, based on the intermediate result set, such that up to a predetermined number of players are identified in the second output screen.

As will be appreciated from the description above, certain example embodiments enable players to define the games that they play within a broader competition. The game manager can assess the players' performances even though different games are defined and played by the different players. This approach differs from conventional fantasy sports and the like. That is, in conventional fantasy gaming, players have some degree of control over how to field a team (e.g., different players can be drafted), but the game fundamentally is the same (e.g., in that everyone in a given competition is playing a particular game, like fantasy baseball or fantasy football). In marked contrast, certain example embodiments enable a fantasy baseball player to compete head-to-head with a fantasy football player, and they may compete head-to-head with players playing more traditional video game stages, players betting on sporting events, and/or others. This is a totally different manner of gameplay enabled by a technology backbone that facilitates selections among and between a wide variety of different building blocks available from a wide range of different play styles, and independent trustworthy comparisons of results for individual players playing custom games in a broader competitive landscape.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1-20. (canceled)

21. An information processing system, comprising:
a memory operably coupled to one or more processors configured to at least:
define a group competition for a plurality of players, wherein each of the plurality of players is assigned to at least one of two or more groups that participate in the group competition such each group has at least two of the players assigned thereto;
enable each player to use a graphical user interface (GUI) to define a game to be played for that player in connection with the defined group competition, each of the defined games including at least one building block selected by the player that defined the respective game using the GUI, the GUI being customized for the group competition, each of the building blocks having a difficulty level associated therewith, wherein the games are differently definable by the players such that different numbers and types of building blocks are selectable by the players in defining the respective games, wherein different building blocks are associated with different competitive events, and wherein different players can select the same or different building blocks in defining their respective games;
for each player, calculate a value based on the difficulty level(s) associated with the building block(s) in the game defined by the respective player;
for each group:
determine an intermediate result set by comparing the calculated values for at least some of the players in the respective group, the intermediate result set for the respective group representing a respective list and identifying at least some of the calculated values and/or the players associated therewith;
select up to a predetermined number of entries from the respective list that represents the intermediate result set; and
determine a respective group result based on the selected entries;
determine a group result set by comparing the respective group results; and
generate for display a first output screen based on the group result set.

22. The information processing system of claim 21, wherein the one or more processors is/are further configured to determine whether each player has been unsuccessful with respect to any of the building blocks in the games that the respective players defined.

23. The information processing system of claim 22, wherein for each player that has been unsuccessful with respect to any of the building blocks in the games that the respective players defined, values are not calculated, and/or are not considered in the determining of the intermediate result set.

24. The information processing system of claim 21, wherein the values are calculated in accordance with a predefined formula and the predefined formula is defined such that the player having selected the most building blocks will not necessarily have the highest possible values.

25. The information processing system of claim 21, wherein the values are calculated by combining the difficulty levels associated with each building block.

26. The information processing system of claim 21, further comprising an interface to an external system, the external system having or providing a list of potential building blocks and current difficulty levels for the potential building blocks.

27. The information processing system of claim 21, wherein for each group, the entries that are selected from the respective list that represents the intermediate result set are the entries having the corresponding highest calculated values.

28. The information processing system of claim 27, wherein for each player that has been unsuccessful with respect to any of the building blocks in the games that the respective players defined, values are not calculated, and/or are not considered in the determining of the intermediate result set, and
wherein the values are calculated in accordance with a predefined formula and the predefined formula is defined such that the player having selected the most building blocks will not necessarily have the highest possible values.

29. The information processing system of claim 21, wherein for each group, the entries that are selected from the respective list that represents the intermediate result set are the entries having the corresponding highest calculated values, except that no player can contribute more than a predetermined number of player entries.

30. The information processing system of claim 21, wherein each game is required to have more than one building block.

31. The information processing system of claim 21, wherein each group is required to have at least a minimum threshold number of players assigned thereto in order to be eligible to compete in the group competition.

32. The information processing system of claim 21, wherein the first output screen is generated to identify the groups having the highest determined group results, based on the group result set, such that up to a predetermined number of groups are identified in the first output screen.

33. The information processing system of claim 32, wherein when a given player accesses the first output screen, the first output screen is generated to identify the group(s) to which the given player is assigned and to include the group result(s) associated therewith.

34. The information processing system of claim 21, wherein the one or more processors is/are further configured to generate for display a second output screen, the second output screen being generated responsive to a given user selecting a given group in the group competition, and the second output screen being generated to identify the players having the highest calculated scores for the given group, based on the intermediate result set, such that up to a predetermined number of players are identified in the second output screen.

35. An information processing method for use with the information processing system of claim 21, the method comprising enabling a given player to define a given game and participate in the group competition with the given game.

36. An information processing method for use with the information processing system of claim 21, the method comprising defining and running the group competition.

37. A non-transitory computer readable storage medium tangibly storing instructions that, when executed, perform the information processing method of claim 35.

38. A non-transitory computer readable storage medium tangibly storing instructions that, when executed, perform the information processing method of claim 36.

39. A user device including at least one processor configured to execute the method of claim 35.

40. A computing system including at least one processor configured to execute the method of claim 36.
